(19) United States
(12) Patent Application Publication
(10) Pub. No.: US 2013/0132547 A1
(43) Pub. Date: May 23, 2013

(54) Apparatus and Method for Address Book Automation Over a Trust Network

(71) Applicant: Respect Network Corporation, San Francisco, CA (US)

(72) Inventor: Drummond Shattuck Reed, Seattle, WA (US)

(73) Assignee: RESPECT NETWORK CORPORATION, San Francisco, CA (US)

(21) Appl. No.: 13/664,343

(22) Filed: Oct. 30, 2012

Related U.S. Application Data
(63) Continuation-in-part of application No. 13/466,921, filed on May 8, 2012.
(60) Provisional application No. 61/484,159, filed on May 9, 2011.

(51) Int. Cl. H04L 12/24

(52) U.S. Cl. CPC H04L 41/00
USPC 709/223

(57) ABSTRACT

A non-transitory computer readable storage medium includes executable instructions to receive a request from a client to enroll in a trust network. The trust network is a group of entities that communicate in a digital network where communications between the entities are quantified to produce measures of entity trustworthiness. A registration form is supplied to the client in response to the request. Client data in the registration form received from the client is processed to load the client data as parameters in a managed trust network. Wherein the client data includes client address book contacts. The client address book contacts are administered in accordance with the trust network measures of entity trustworthiness.

### CROSS-REFERENCE TO RELATED APPLICATION

This application is a continuation-in-part of U.S. patent application Ser. No. 13/466,921, filed May 8, 2012, entitled “Apparatus and Method for Managing a Trust Network”, the contents of which are incorporated herein by reference.

### FIELD OF THE INVENTION

This invention relates generally to digital data processing. More particularly, this invention relates to techniques for forming data sharing relationships over a trust network.

### BACKGROUND OF THE INVENTION

The Internet has become the common network connecting many other types of digital networks and devices for communications and data interchange. As such, it has increasingly become the platform for new ways to form and manage communications and data sharing relationships. Starting in the mid-1990s, email using the open standard SMTP protocol became the first “killer app” for the Internet due to its ability to exchange electronic messages between senders and receivers in minutes using only an email address. This was rapidly followed by the emergence of instant messaging systems like AOL Instant Messenger™, Jabber, Skype™, and GTalk™, that let users exchange text messages in real time over the Internet. In some cases these systems also support real-time voice communications using VoIP or other digital voice communications technologies. In the last decade, social networks like Facebook™ and Twitter™ achieved tremendous growth by enabling their members to very easily and quickly form connections (“friends” on Facebook or “followers” on Twitter) that enabled them to subscribe to feeds of messages, news, photos, and other forms of information from each other. And more recently there has been strong adoption of Internet file sharing services such as Dropbox™ and Box™ that allow users to share digital files both publicly and privately.

All of these communications systems generally require that a user maintain some form of address book, friend list, “buddy list”, or other directory of contacts representing the communications and data sharing relationships that the user wishes to invoke over the system. For the purposes of this specification, this communications directory function will be referred to as an address book. In centralized networks like Facebook and Twitter, or on networks that explicitly offer address portability, the contact data in this address book does not need to change because the user does not “move” on the network. However, for other networks that do not offer address portability, or for communications relationships that depend on contexts that may change over time (such as schooling, employment, physical residency, etc.), the contact data in a user's address book must be updated when a contact's information changes or the communications relationship will be impaired or severed.

This address book management and synchronization problem is compounded when a user employs multiple devices for communications, such as a desktop computer, a laptop computer, a tablet computer, a smartphone, etc. It is further compounded when multiple applications on those devices each require their own address books, e.g., email, instant messaging, social networking, file sharing, etc.

Many solutions to address book management and synchronization have been developed. Some are designed to solve the problem of a single user needing to synchronize address books across multiple devices, such as a smart phone and an email service. Examples include Apple iTunes™ and Google Sync.™ Others are network-based address books that are designed to solve the problem of synchronizing contact information among particular groups of users, such as the employees of a workgroup or a company. Examples include Microsoft Outlook™ running in conjunction with Microsoft Exchange™ or Microsoft Active Directory.™ Others are Internet-based services that attempt to solve the problem of synchronizing individual address book entries between individuals that are not members of the same group or company. Examples include P1axo™ and AboutOne.™

However, despite the universality of the problem and the growing need for a comprehensive solution, none of these solutions for address book automation has achieved more than a fraction of market share. Even the very largest of the address book synchronization services, such as Plaxo, or social networks, such as Facebook, have not grown to become ubiquitous for at least two reasons. First, many market participants do not trust sharing sensitive contact information via centralized services due to concerns about privacy, data centralization, and data ownership. Second, market participants do not trust proprietary services with unproven business models for relationship management, data sharing, and data synchronization functions that are essential to their personal or commercial success, especially when compared to open-standard, multi-provider networks such as the SMTP email and HTTP Web networks.

In view of the foregoing, new techniques are needed for address book automation.

### SUMMARY OF THE INVENTION

A non-transitory computer readable storage medium includes executable instructions to receive a request from a client to enroll in a trust network. The trust network is a group of entities that communicate in a digital network where communications between the entities are quantified to produce measures of entity trustworthiness. A registration form is supplied to the client in response to the request. Client data in the registration form received from the client is processed to load the client data as parameters in a managed trust network. Wherein the client data includes client address book contacts. The client address book contacts are administered in accordance with the trust network measures of entity trustworthiness.

An embodiment of the present invention provides a system and method for forming connections between members of a trust network to enable address book automation. These connection capabilities include automatic connections, semi-automatic connections, and connections initiated through optical scanning.

### BRIEF DESCRIPTION OF THE DRAWINGS

FIG. 1 is a block diagram illustrating an embodiment of the present invention using a dumb client and a server.

FIG. 2 is a block diagram illustrating an embodiment of the present invention using a smart client and a server.

FIG. 3A is a key to the XDI graph notation used in subsequent figures.

FIG. 3B illustrates a conceptual example of the notation in FIG. 3A.

FIG. 4A illustrates the first portion of an example XDI graph showing properties of a digital identity for a person.

FIG. 4B illustrates the second portion of an example XDI graph showing metadata about the properties in FIG. 4A.

FIG. 4C illustrates the third portion of an example XDI graph showing versioning metadata about the properties in FIG. 4A.

FIG. 4D illustrates the fourth portion of an example XDI graph showing personas of the digital identity in FIG. 4A.

FIG. 5 illustrates an example XDI graph including a link contract.

FIG. 6 illustrates an example XDI graph representing an XDI message.

FIG. 7A illustrates the XDI message template for a signed message.

FIG. 7B illustrates an example set of XDI statements in an XDI message.

FIG. 8 illustrates the JSON serialization of the XDI message in FIG. 7B.

FIG. 9 illustrates the JSON serialization of an XDI message with a $add operation.

FIG. 10 illustrates the JSON serialization of an XDI message with a $mod operation.

FIG. 11 illustrates the JSON serialization of an XDI message with a $del operation.

FIG. 12 illustrates a splash screen that may be utilized in accordance with an embodiment of the invention.

FIG. 13 illustrates a setup screen that may be utilized in accordance with an embodiment of the invention.

FIG. 14 illustrates a configuration screen that may be utilized in accordance with an embodiment of the invention.

FIG. 15 illustrates address book functionality utilized in accordance with an embodiment of the invention.

FIG. 16 illustrates an exemplary dictionary utilized in accordance with an embodiment of the invention.

FIG. 17 illustrates a configuration screen that may be utilized in accordance with an embodiment of the invention.

FIGS. 18-21 illustrate auto-connection processing operations performed in accordance with embodiments of the invention.

FIG. 22 illustrates a configuration screen utilized in accordance with an embodiment of the invention.

FIGS. 23-24 illustrate update processing utilized in accordance with an embodiment of the invention.

FIG. 25 illustrates a contact connection screen that may be used in accordance with an embodiment of the invention.

FIG. 26 illustrates contact connection processing performed in accordance with an embodiment of the invention.

FIG. 27 illustrates a contact connection failure screen that may be utilized in accordance with an embodiment of the invention.

FIG. 28 illustrates a pending contact connection screen that may be utilized in accordance with an embodiment of the invention.

FIG. 29 illustrates a contact connection completion screen that may be utilized in accordance with an embodiment of the invention.

FIG. 30 illustrates processing operations associated with the use of a smartphone camera to add a new contact in accordance with an embodiment of the invention.

FIG. 31 illustrates processing operations for registering a globally unique identifier utilizing a smartphone camera in accordance with an embodiment of the invention.

### DETAILED DESCRIPTION OF THE INVENTION

The present invention provides a method and system for forming connections between members of a trust network to enable address book automation. The trust network enables connections to be formed automatically from existing address book data, semi-automatically from items of contact data, or initiated through optical scanning

Representations of entities participating in relationships on a digital network are commonly referred to as digital identities. The entity represented by a digital identity may be an individual person, a group of people, an organization of any type, a computing device of any type, a computer software program or service of any type, a semantic concept or category of any type, or any other type of entity requiring identification on a network.

In one embodiment the trust network is implemented using a network of clients and servers that cooperate to maintain a logical graph of information describing the relationships between members of the trust network, the data associated with each member, and the permissions each member grants to other members to access and operate on the data and relationships described in the graph.

This logical graph may be represented and serialized using many different data structures and serialization formats. In a preferred embodiment, open standard formats are used for interoperability. One such format is XML as defined by the World Wide Web Consortium in XML 1.1 (Second Edition) and XML Schemas 1.1. Another format is JSON as defined by the Internet Engineering Task Force in RFC 4627. Another format particularly suited for describing graphs is RDF (Resource Description Framework) as defined by the World Wide Web Consortium.

In an embodiment, the XDI format is used as defined by the XRI Data Interchange (XDI) Technical Committee at the Organization for the Advancement of Structured Information Standards (OASIS). While similar to and building upon the RDF format, the XDI format is used in one embodiment because the XDI graph model includes support for addressability of all nodes of the graph, modeling of contexts (graphs that contain graphs), mapping of reassignable to persistent identifiers, and a very simple grammar for describing the fundamental relationships in directed graphs. This grammar is called the XDI metagraph vocabulary. In addition XDI is also a semantic data interchange protocol defined in the XDI format. This protocol includes support for the four atomic graph operations: get (read), add (insert), modify (update), and delete. Each of these operations acts directly on a set of XDI statements in the graph, where every XDI statement represents one arc in the graph. XDI also includes support for graph structures that describe the permissions associated with other graph structures, called XDI link contracts. Link contracts are particularly useful for portable, cross-domain authorization. XDI graphs and XDI protocol messages may be serialized in any of the open standard data formats described herein. In an embodiment the JSON serialization format it used due to its simplicity, compactness, and efficiency. The XDI graph format, JSON serialization, metagraph vocabulary, protocol operations, link contracts, and messages are described in a public document published by the XDI Technical Committee called The XDI Graph Model and in other related public documents on the XDI Technical Committee website.

Both RDF and XDI are based on open standard Internet identifier formats. RDF is based on the World Wide Web and IETF Uniform Resource Identifier (URI) as defined in RFC 3986 and Internationalized Resource Identifier (IRI) standards as defined in RFC 3987. These standards define how Internet IP addresses and DNS names may be combined with local resource identifiers (such as filenames) to create hierarchical global identifiers that are the basis for the World Wide Web. This architecture has been extended by the OASIS Extensible Resource Identifier (XRI) Technical Committee standards for structured identifiers. XRI global registry infrastructure has been implemented by XDI.org as specified in the XDI.org Global Services Specifications Version 1.0 specification.

XRIs enable expression of abstract identifiers than can be composed of other XRIs as well as URIs or IRIs. Besides composition of structured identifiers, XRIs are well-suited to cross-domain information sharing because they are designed to be domain- and application-independent; they provide mechanisms for encapsulation and reuse of existing identifiers across contexts (called XRI cross-references); they support mapping of human-friendly, reassignable identifiers (referred to as i-names) to persistent, machine-friendly identifiers (referred to as i-numbers); they provide a uniform protocol for resolution of an i-name or i-number to discovery of concrete service endpoint identifiers; and this protocol includes three trusted resolution modes for security protection (HTTPS, SAML, and HTTPS+SAML).

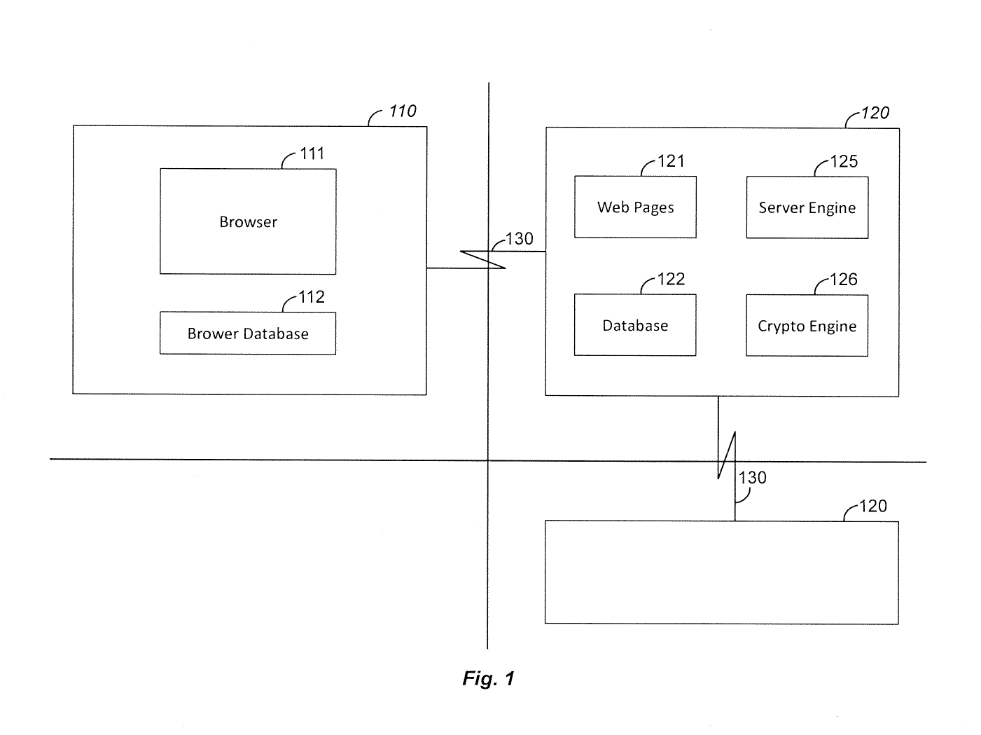

FIG. 1 illustrates an embodiment of the present invention. This embodiment uses standard client-server architecture including client 110 and server 120. In this embodiment client 110 does not include software with special-purpose capabilities for accessing or processing information from server 120, so it is referred to as a “dumb client” or “thin client”. In a dumb client embodiment, the client software used to access server 120 is a web browser 111. To save state, such as HTTP cookies or other client identifiers provided by server 120, web browser 111 includes browser database 112. Browser 111 may optionally be augmented by a plug-in module with special features for securing or displaying communications or notifications from server 120. Dumb client 210 may operate on any device containing the necessary software and communications capabilities, including desktop computers, laptop computers, smartphones, car computers, set-top boxes, or on a server 120. The type of client device is not a limiting feature of the invention.

The server 120 includes various web pages 121 for display of information, database 122 for storage of information, server engine 125 for general processing operations, and crypto engine 126 for cryptographic processing operations. Cryptographic operations include generation of public/private key pairs, generation and signing of digital certificates, generation and verification of digital signatures, and encryption and decryption of incoming and outgoing messages from server 120. Client 110 and server 120 communicate over a data communication protocol 130. Multiple instances of server 120 may also communicate over data communications protocol 130. Data communications protocol 130 may be any network protocol that permits data transfer between the client 110 and server 120, including the Internet, a telephone network, a satellite network, or any other network. If the network protocol 130 is a transport level protocol such as TCP/IP, it may transport data using any desired application level protocol such as HTTP, HTTPS, SMTP, XMPP, LDAP, SIP, or XDI. The type of communications network or data communications protocol 130 is not a limiting feature of the invention.

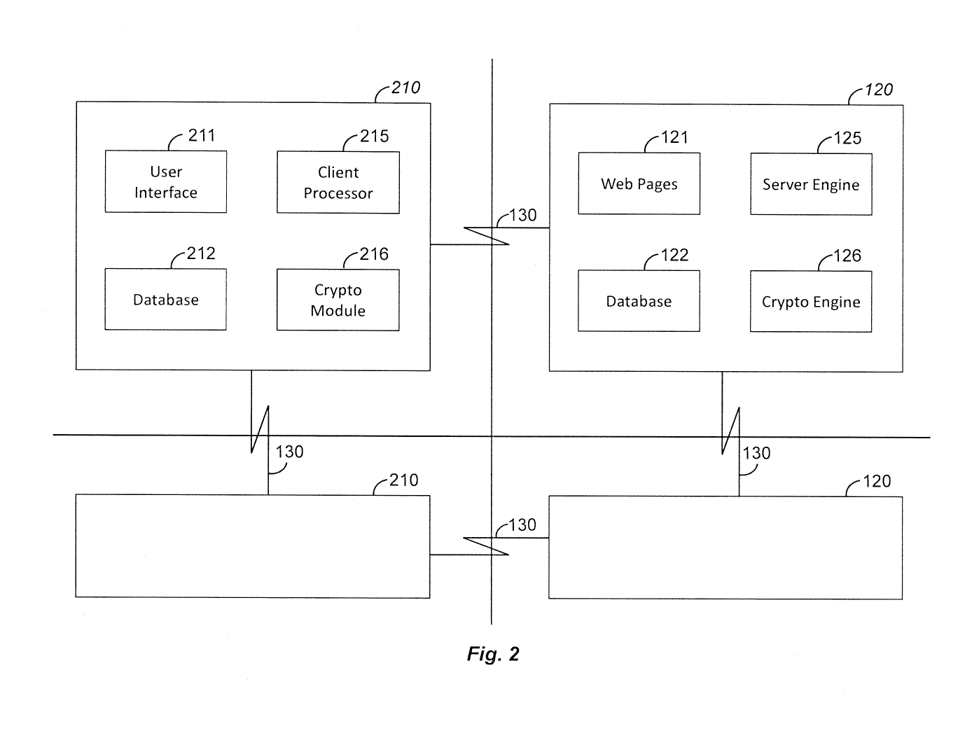

FIG. 2 illustrates an alternate embodiment of the present invention. In this embodiment, client 210 is called a “smart client” because it includes special capabilities for processing communications with server 120. Smart client 210 includes a user interface 211, a database 212, a client processor 215 for general client processing operations, and a crypto module 216 for cryptographic processing operations. Crypto module 216 is optional for smart clients that may have other operating system or local processing functions capable of securely communicating with the trust network. User interface 211 may provide its own user display capability, or it may call another application or component on client 110 for user display and interaction. In one embodiment user interface 211 calls browser 111 in FIG. 1 for user display and interaction. In this embodiment, user interface 211 may be implemented as a local web server. In addition, browser 111 may be optionally augmented by a plug-in module with special features for securing or displaying communications or notifications from user interface 211 or from server 120. Like dumb client 110, smart client 210 may operate on any device with the necessary hardware and software. Examples include smartphones, table computers, laptop computers, desktop computers, GPS devices, car computers, and so on. Smart client 210 communicates with server 120 over data communications protocol 130 in the same way as depicted in FIG. 1. However, because smart client 210 has the necessary capabilities to communicate on a peer-to-peer basis, in another embodiment it may communicate over communications protocol 130 with another instance of smart client 210. This peer-to-peer communications capability may have special utility with regard to discovery and establishment of new trust relationships, efficient communication directly between client devices, and secure, private transfer of data. In this fashion any configuration of smart clients 210 and servers 120 may communicate and collaborate to maintain the data structures of the present invention.

The clients 110 and 210 and servers 120 depicted in FIGS. 1 and 2 cooperate to maintain a logical graph of information describing the relationships between members of the trust network and the data, metadata, permissions, and messages they share. In an embodiment this uses an XDI graph model.

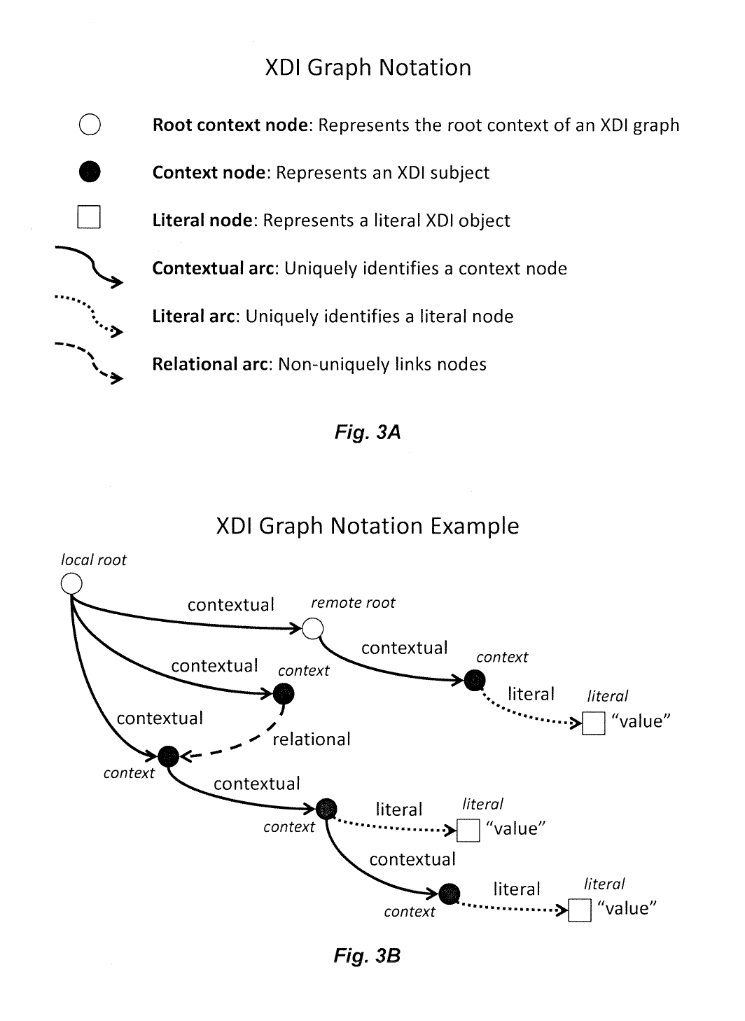

FIG. 3A is a description from The XDI Graph Model of the notation developed by the OASIS XDI Technical Committee to visually depict XDI graphs. FIG. 3B is a conceptual example from The XDI Graph Model showing how this notation is used. The functional meaning of contextual arcs, relational arcs, and literal arcs is explained in The XDI Graph Model. In summary, XDI literal arcs are analogous to RDF arcs whose object is an RDF literal; XDI relational arcs are analogous to RDF arcs whose object is a URI; and XDI contextual arcs are analogous to RDF arcs whose object is a blank node, with a key difference being that XDI contextual arcs are uniquely addressable.

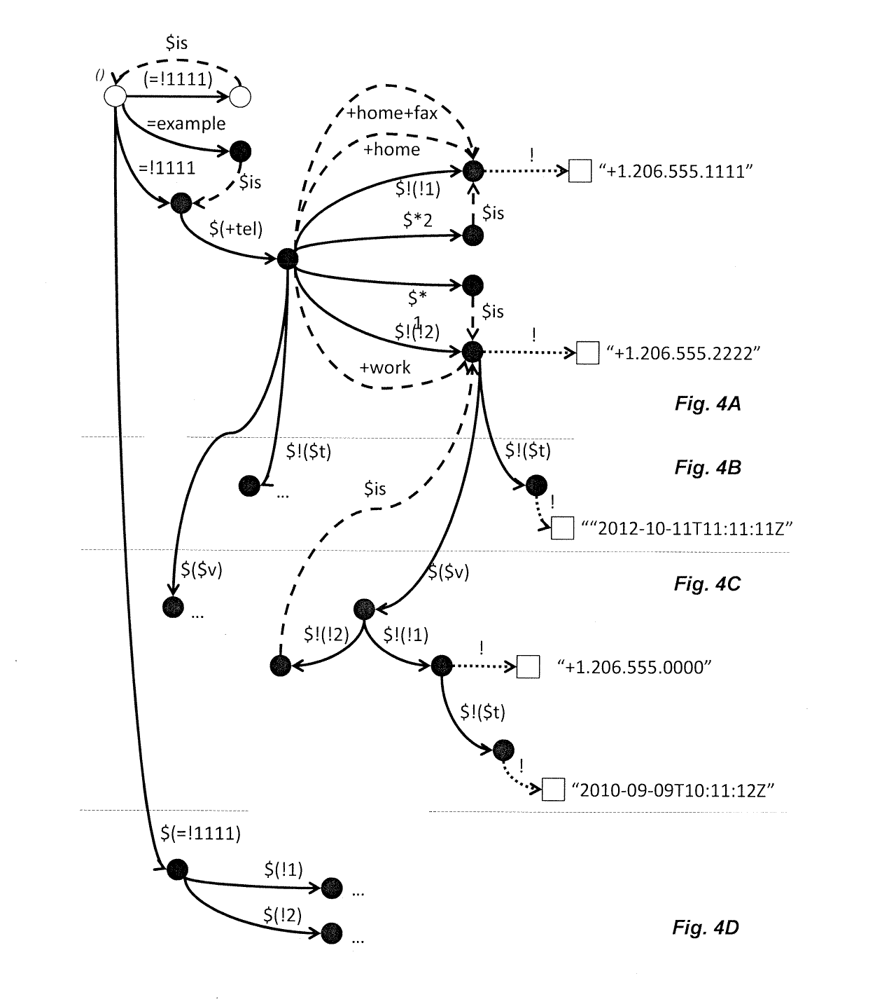

FIGS. 4A, 4B, 4C, and 4D illustrate different portions of an example XDI graph representing the digital identity of a person. Such a representation of an XDI graph in any format is called an XDI document. One of the advantages of XDI is that every node in an XDI graph is uniquely addressable using an XRI as explained in The XDI Graph Model. This is called the XDI address of the node. FIG. 4A shows the root context node of the graph as an open circle. This node, called the local root node, has the special XDI address ( ). This special address is shared as the root node of all XDI documents and is not included in the XDI address of any node within the document. In this example there is a contextual arc labeled (=!1111), whose object is another open circle representing another root node, called a remote root node. This node has a relational arc labeled $is pointing back to the local root node. This establishes logical equivalence between these two XDI addresses. This combination of a remote root node and a $is relation to the local root node provides a means of identifying the absolute XDI address of this local XDI graph on the network. By using the URI property of a root context node, that XDI address may be resolved to the location of this XDI graph on the network, called the XDI endpoint. This resolution process, called XDI discovery, is defined on the XDI Technical Committee website.

In this example there is also a contextual arc labeled =!1111. This represents the root of a digital identity for a person. The = sign represents the XRI personal identifier namespace, and the ! sign represents persistent identifiers within this namespace, i.e., identifiers that are assigned once to a resource and never reassigned to another resource. In Web architecture this is referred to as a URN (Uniform Resource Name). In XRI architecture this type of identifier is referred to as an i-number. The use of persistent identifiers in digital identity systems is important from a security standpoint so that a digital identity assigned to one person is not subsequently “taken over” or “recycled” by another person. The number 1111 represent the unique i-number assigned in the =! namespace. This i-number is used for example purposes only.

Because an i-number is intended for persistence and not human-memorability, XRI architecture supports a second type of identifier called an i-name. I-names are intended to be easy for humans to recognize and remember in any language. In FIG. 4A the second arc from the root context node, labeled =example, is an example of an i-name. The context node identified by the =example arc then has a relational arc labeled $ whose object is the context node identified by the i-number =!1111. As explained in The XDI Graph Model, the relational arc $ expresses a synonym relationship, i.e., that the person identified by the i-name =example is the same person identified by the i-number =!1111. In this way the i-name =example is mapped to the i-number =!1111 to identify the persistent XDI address associated with any i-name. It is recommended that all XDI digital identities be rooted on persistent XDI addresses so links to them will not break when an i-name is changed or reassigned. This patent specification will use i-numbers for that reason. Note that XRIs in the + namespace, for generic identifiers, and the $ namespace, for special identifiers defined by the OASIS XDI Technical Committee, will use i-names because these are effectively persistent.

In FIG. 4A, one contextual arc labeled $(+tel) originates from the =!1111 context node. This identifies a context node, also called a subcontext, representing a set of telephone numbers. The label $(+tel) is an example of XDI multiplicity syntax representing a collection as explained in The XDI Graph Model and on the XDI TC website. The XRI subsegment identifying a collection must begin with the XDI delimiters $(. A collection contains zero or more instances of subcontexts that represent members of the collection. These members are singletons representing either entities or attributes. Entity singletons do not have literal nodes, while attribute singletons have zero or one literal node. The XRI subsegment identifying an entity singleton member of a collection must begin with $(!, while the XRI subsegment identifying an attribute singleton member of a collection must begin with $!(!. In this case the members are attribute singletons represent telephone numbers. In FIG. 4A, the =!1111$(+tel) context node has two contextual arcs labeled with the i-numbers $!(!1) and $!(!2) that identify these attribute singletons. Each has a literal arc labeled ! that identifies a literal node containing the actual data values. The value of the $!(!1) literal arc is +1.206.555.1111, and the value of the $!(!2) literal arc is +1.206.555.2222. The combination of the XDI subject represented by the path of contextual arcs, the XDI predicate represented by the literal arc, and the XDI object represented by the data value can then be combined into a single XRI representing an XDI statement by inserting forward slashes between the subject, predicate, and object. Note that if the object is a literal value, the data is encoded first as a Data URI and then as an XRI as explained in The XDI Graph Model. The resulting XDI statements expressing these two phone numbers are given below:
=!1111$(+tel)$!(!1)/!/(data:,+1.206.555.1111)
=!1111$(+tel)$!(!2)/!/(data:,+1.206.555.2222)

The single character ! as the XDI predicate signifies that the XDI object is a literal. This rule provides semantic precision about which XDI statements identify XDI literals.

In FIG. 4A, there are a set of relational arcs originating from the +tel node labeled $*1, $*2, +work, +home, and +home+fax. The $*1 and $*2 relational arcs provide a means of ordering the XDI literal nodes for applications that need order or priority metadata. For example, an application may need to know which is the primary telephone number and which is the secondary telephone number. The +work, +home, and +home+fax arcs provide a means of typing the XDI literal nodes so it is clear which literal node represents which type of telephone number.

FIG. 4B illustrates metadata about the telephone properties expressed in FIG. 4A. The specific example shown is a contextual arc originating from the =!1111$(+tel)$!(!2) context node labeled $!($t). This identifies an attribute singleton representing a date stamp describing the time at which the parent context node was last changed. The XDI statement representing this metadata is:
=!1111$(+tel)$!(!2)$!($t)/!/(data:,2010-11-11T11:11:11Z)

FIG. 4C illustrates versioning metadata about the telephone attributes expressed in FIG. 4A. The specific example shown is a contextual arc originating from the =!1111$(+tel)$!(!2) node labeled $($v). This identifies the context node that serves as the root of the version subgraph for this attribute singleton. The two contextual arcs originating from the =!1111$(+tel)$!(!2)$($v) node labeled $(!1) and $(!2) represent the first two versions of the =!1111$(+tel)$!(!2) attribute singleton. The first version has the XDI address =!1111$(+tel)$!(!2)$($v)$!(!1) and the second version has the address =!1111$(+tel)$!(!2)$($v)$!(!2). FIG. 4C shows that the first version had the literal value and timestamp metadata described by the following two XDI statements:
=!1111$(+tel)$!(!2)$($v)$!(!1)/!/(data:,+1.206.555.0000)
=!1111$(+tel)$!(!2)$($v)$!(!1)$!($t)/!/(data:,2010-09-09T10:11:12Z)

The second version identified in FIG. 4C is the current version. This is indicated by a relational arc originating from =!1111+tel$v!2 with the $is label to indicate equivalence. The object is =!1111$(+tel)$!(!2), which is the current version. Although not shown in FIG. 4C, in XDI the identity of the current version may also be discovered from the other direction by using a relational labeled $v from context node =!1111$(+tel)$!(!2) to the object =!1111$(+tel)$!(!2)$($v)$!(!2).

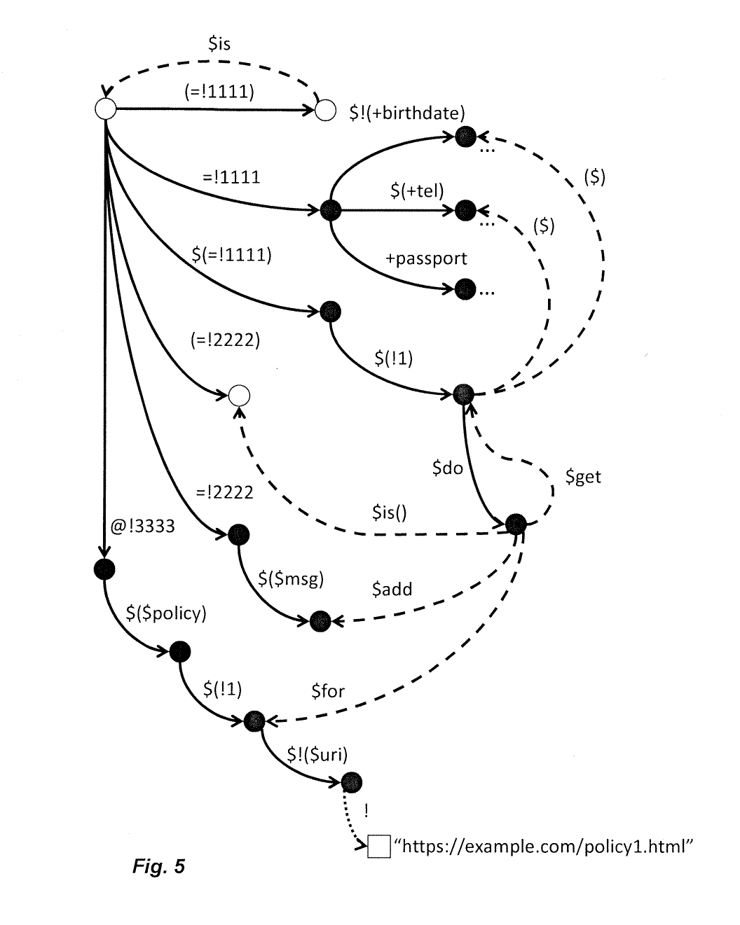

FIG. 4D illustrates how XDI can represent personas, i.e., different representations of the digital identity of a person (or any other entity requiring persona capabilities). Because a person may have zero or more personas, this is represented by a collection with the label $(=!1111). The entity singletons within this collection that represent the individual personas are labeled with the contextual arcs $(!1) and $(!2), giving them the absolute XDI addresses $(=!1111)$(!1) and $(=!1111)$(!2). Personas may have their own properties (not shown in FIG. 4D), or they may reference properties of their parent context node (shown in FIG. 5). This enables properties to be easily shared among multiple personas, while also enabling personas to have their own persona-specific properties.

FIG. 5 illustrates an example XDI graph again showing a portion of the digital identity represented by the context node =!1111 and the persona $(=!1111)$(!1) (the persona $(=!1111)$(!2) is not shown in this figure). In this graph, the local root context node also contextual arcs labeled (=!2222), and =!2222.

The context node =!1111 is shown with one attribute singleton $!(+birthdate), one attribute collection $(+tel) (as shown in FIG. 4), and one entity singleton +passport. The details of these subgraphs not shown in FIG. 5. The persona $(=!1111)$(!1) has two relational arcs labeled ($) whose objects are =!1111$!(+birthdate) and =!1111$(+tel). ($) is the XDI variable identifier. This means that the objects identified by a ($) relational arc are included by reference in the parent context. This is how entities and attributes may be shared across personas.

The persona =$(=!1111)$(!1) also has a contextual arc labeled $do. This identifies the root context node of an XDI link contract. A link contract is the graph structure used in XDI to describe authorization, i.e., the set of permissions granted by one digital identity to another to perform operations on a portion of the XDI graph. The atomic XDI operations, $get (read), $add (insert), $mod (replace), and $del (delete) and the composite XDI operations $copy and $move are explained in The XDI Graph Model. The link contract represented by the context node $(=!1111)$(!1)$do has four relational arcs labeled $is( ), $get, $add, and $for. As explained in The XDI Graph Model, the XDI metagraph symbol ( ) is used as an XDI predicate to express the child context nodes of an XDI subject. The inverse, $is( ), is used to express the parent context nodes of a XDI subject. Note that while any given context node has exactly one XDI address relative to the root context node an XDI document, that same logical context node may appear as a subgraph relative to other XDI context nodes. This is how XDI subgraphs are shared between XDI documents. This relative context relationship is expressed with the $is( ) predicate. In FIG. 5, the $is( ) relational arc expresses that the link contract =$(=!1111)$(!1)$do is shared with the XDI graph at the XDI address (=!2222). This is how the set of permissions defined by the link contract are assigned to another digital identity. In this case the link contract $(=!1111)$(!1)$do is assigned to =!2222, the digital identity authoritative for the XDI graph at (=!2222). This means a copy of this link contract subgraph logically exists in the XDI graph whose root context node has the XDI address (=!2222). The complete XDI statement expressing this assignment is:
$(=!1111)$(!1)$do/$( )/(=!2222)

The relational arc labeled $get originating from the $(=!1111)$(!1)$do link contract has the object $(=!1111)$(!1), which means that the recipient of the link contract has permission to access the XDI subgraph rooted on the context node $(=!1111)$(!1). This is one of the personas of the person represented by =!1111. Since in this case this persona includes the two relational arcs ($) explained above, that means the recipient has permission to read the birthdate attribute and telephone number collection of =!1111, but not the passport property. The complete XDI statement expressing this permission is:
$(=!1111)$(!1)$do/get/$(=!1111)$(!1)

Although not shown in FIG. 5, the XDI operation $copy is identical to $get in terms of providing access permission, but $copy also subscribes the recipient to all changes in the subgraph that is the object of the $copy statement. This includes $add, $mod, or $del operations. For example, if =!1111 adds a new telephone number to its =!1111$(+tel) context, or modifies a telephone number in that context, or deletes the =!1111$!(+birthdate) attribute, or adds a new property to its $(=!1111)$(!1) persona, these changes will automatically be applied to a copy of this subgraph maintained at the XDI endpoint (=!2222). This is referred to as an XDI synchronization relationship.

The relational arc labeled $add originating from the =!1111!1$do link contract has the object =!2222$($msg). $msg is the special XDI identifier for XDI messages. This means the link contract grants permission for the recipient to add XDI messages to the subgraph rooted on =!2222!$($msg). From an XDI perspective, this is the equivalent of a “whitelist”, i.e., a means of expressing which digital identities are permitted to send =!1111 XDI messages. The complete XDI statement expressing this permission is:
$(=!1111)$(!1)$do/$add/=!2222$($msg)

The relational arc labeled $for originating from the $(=!1111)$(!1)$do link contract has the object =!3333$($policy)$(!1). @!3333 is an i-number assigned in the @ namespace, the XRI global context symbol for organizational identifiers, i.e., identifiers for a legal entity other than a person. $policy is the special XDI identifier for data rights policies, also called data exchange policies, data interchange polices, or data sharing policies. A data rights policy may be any rule set used to govern communications and data exchange relationships. A data rights policy may be expressed in either a human-readable document such as a Web page or PDF file, or in a machine-readable policy expression language such as XACML from the OASIS XACML Technical Committee. A data rights policy may also be expressed in both human-readable and machine-readable formats. A data rights policy may also be expressed in more than one human language and in more than one machine-readable policy expression language. XDI itself may be used to express a machine-readable policy expression language, though such a language has not yet been defined by the OASIS XDI Technical Committee. The particular policy expression language used is not a limiting feature of the invention. In FIG. 5, the $for relational arc means that the permissions grant by the digital identity =!1111 to the recipient =!2222 under the link contract $(=!1111)$(!1)$do are subject to the policy @!3333$($policy)$(!1). The complete XDI statement expressing this policy association is:
$(=!1111)$(!1)$do/$for/@!3333$($policy)$(!1)

In the example XDI graph illustrated in FIG. 5, @!3333$($policy)$(!1) serves as the persistent logical XRI identifier of the policy, which then may have multiple representations as described above. FIG. 5 shows only one representation, as an HTML document available via the HTTPS protocol at the URI “https://example.com/policy1.html”. This is expressed by the context node @!3333$($policy)$(!1) having a contextual arc labeled $!($uri) to identify an attribute singleton containing the URI identifying the location of this policy. The complete XDI statement expressing this policy location is:
@!3333$($policy)$(!1)$!($uri)/!/(data:, https://example.com/policy1.html)

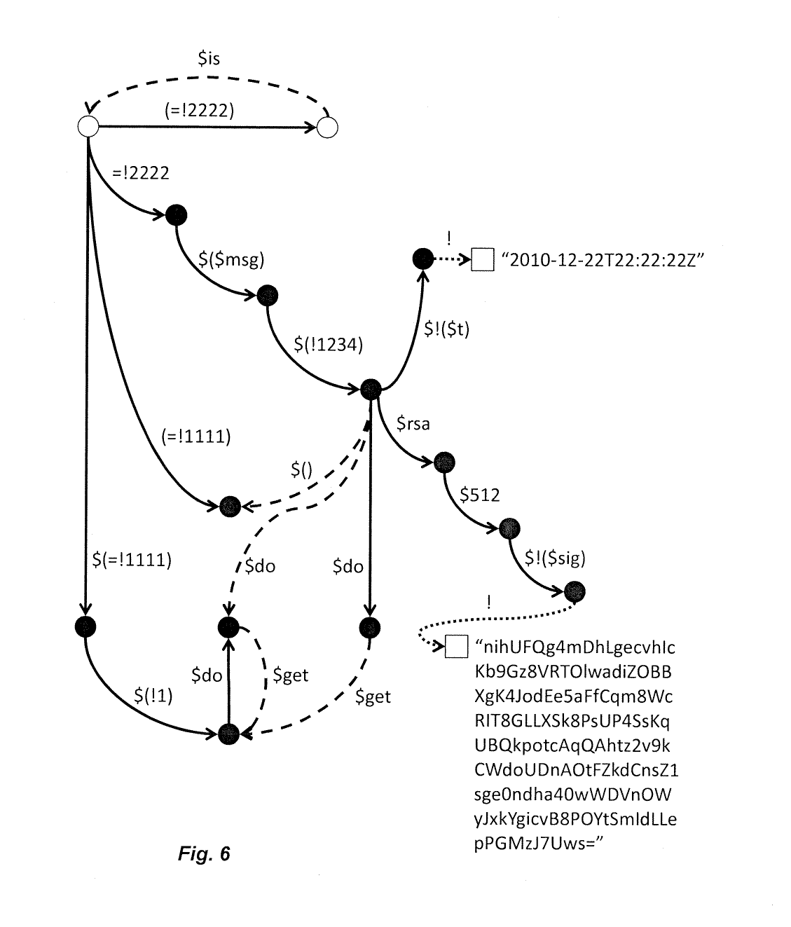

FIG. 6 illustrates an example XDI graph showing an XDI message that would be sent from digital identity =!2222 to digital identity =!1111 under the terms of the link contract illustrated in FIG. 5. The originating XDI endpoint is expressed by the relational arc on the root context node labeled $is whose object is (=!2222). The originating sender is the digital identity identified by the contextual arc =!2222. The context node =!2222 has the contextual arc $($msg) to identify the context for XDI messages. The context node =!2222$($msg) has the contextual arc $(!1234) to identify a specific instance of a message. The context node =!2222$($msg)$(!1234) has three subcontexts: $!($t) for a timestamp on the message, $rsa$512$!($sig) for a digital signature on the message, and $do to identify the XDI operation(s) the message will request. It also has the relational arc $( ) to identify the recipient(s) of the message. In this example there is only one recipient of the message, (=!1111), and only one operation requested, which is a $get operation on the subgraph rooted on the XDI address $(=!1111)$(!1). Finally, the context node =!2222$($msg)$(!1234) also has the relational arc $do that identifies the target link contract. The target link contract is the link contract that the receiving XDI endpoint must evaluate in order to make an authorization decision about the operations being requested by the XDI message. Requiring the target link contract to be included in each XDI message makes it much more efficient for XDI endpoints to do the processing necessary to make authorization decisions.

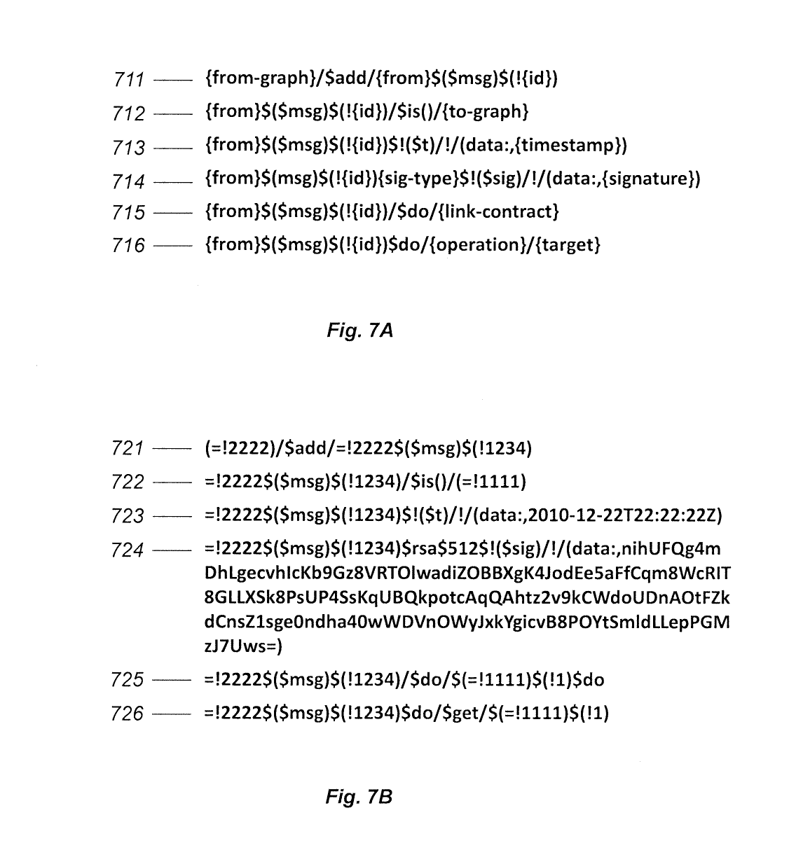

FIG. 7A illustrates the template for a signed XDI message in XDI statement format as explained on the XDI Technical Committee website. Each character string in squiggly brackets, e.g., {from}, indicates a variable in the template. The {from-graph} variable represents the XDI endpoint from which the message originates. The {from} variable is the XRI for the digital identity representing the sender of the message. The {id} variable is the i-number assigned to uniquely identify the message in the sender's XDI message context. The {to-graph} variable is the XRI of the XDI endpoint that is the destination of the message, also called the target context. The {timestamp} variable is the timestamp of the message in XML date time format. The {sig-type} variable is the XRI representing the type of digital signature algorithm used to sign the message. The {signature} variable is the value of the digital signature on the message. The {link-contract} variable is the XDI address of the target link contract. The {operation} variable is the XDI operation being requested by the message. The {target} variable is either the XDI address or the XDI statement on which the operation is requested. $get and $del operations operate against XDI addresses, i.e., context nodes or literal nodes in the graph. $add and $mod operations operate against XDI statements that are either being added (inserted) or modified (replaced) in the graph.

In FIG. 7A, line 711 expresses the XDI endpoint from which the message originates. Line 712 expresses the XDI address of the sender, the message ID, and the XDI address of the target context (recipient). Multiple recipients may be requested in a single message by including multiple instances of the template in line 712. Line 713 expresses the timestamp of the message. Line 714 expresses the type and value of the digital signature on the message. Digital signature types are defined in the $ namespace by the OASIS XDI Technical Committee. An example is $rsa$512 expressing the RSA digital signature algorithm using a 512 byte key size. Line 715 expresses the link contract that is the target of the message. Line 716 expresses the XDI operation requested by the message. Multiple XDI operations may be requested in a single message by including multiple instances of the template in line 716.

As explained in The XDI Graph Model and associated XDI Technical Committee documents, a digital signature is applied to the JSON serialization of the message by applying the following steps: a) ordering all XDI statements in the message exclusive of the digital signature statement in ASCII order, b) performing the JSON serialization without adding any insignificant whitespace, c) calculating the digital signature over the JSON object, and d) appending the XDI statement containing the digital signature value to the JSON serialization. This algorithm has the advantages of very simple and fast canonicalization, so it is less prone to error or misinterpretation that XML dSig or other digital signature formats. However the specific digital signature format is not a limiting feature of the invention.

FIG. 7B illustrates the example XDI message in FIG. 6 in XDI statement format following the template in FIG. 7A. Line 721 of the message corresponds to line 711 of the template; line 722 to line 712; line 723 to line 713; line 724 to line 714; line 725 to line 715, and line 726 to line 716.

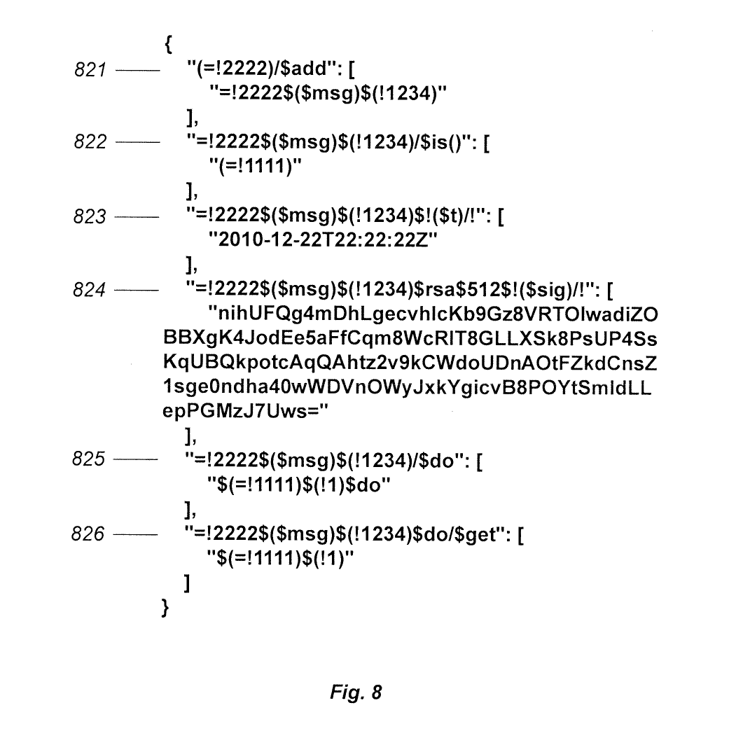

FIG. 8 illustrates the JSON serialization of the XDI message in FIG. 7B. Line 821 of the message corresponds to line 721 of the template; line 822 to line 722; line 823 to line 723; line 824 to line 724; line 825 to line 725, and line 826 to line 726. As explained in The XDI Graph Model, the JSON serialization format is very simple. The XDI graph is serialized in a single JSON object where each XDI statement is one key:value pair. The key is the first two segments of the XDI statement, without a trailing forward slash. The value is a JSON array. The value(s) within this JSON array are interpreted as follows: a) the value is a literal JSON data format if the predicate of the XDI statement consists of only the ! character (signifying an XDI literal arc), b) the value is an XRI if the predicate of the XDI statement is not a literal arc and the array value is a JSON string, and c) the value is a recursive subgraph of XDI statements is if the predicate of the XDI statement is not a literal arc and the array value is a JSON object. This last option enables efficient serialization of XDI subgraphs that are the target of XDI $add and $mod operations.

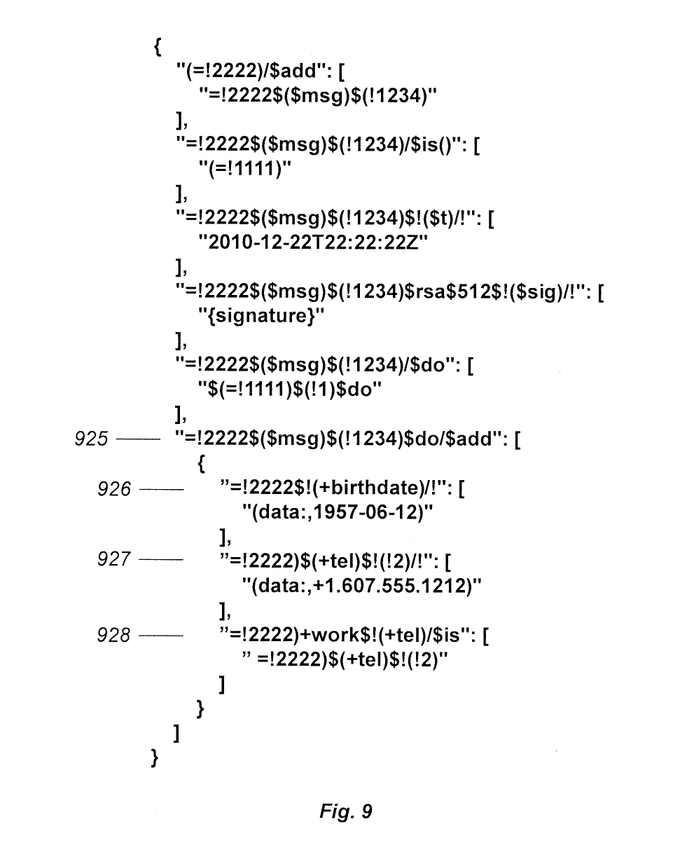

FIG. 9 illustrates the JSON serialization of an XDI message with a $add operation. The first five XDI statements are the same as FIG. 8 (except for the signature value, which is elided for clarity). The operation statement 925 is a $add operation. Since a $add operation operates on a subgraph of XDI statements, the value in the JSON array is a JSON object which recurses the XDI serialization format. The first statement in the subgraph, statement 926, expresses a birthdate literal value to add to the digital identity =!2222. Statement 927 expresses a telephone number to add, and statement 928 expresses the type of this telephone number using a $is equivalence statement.

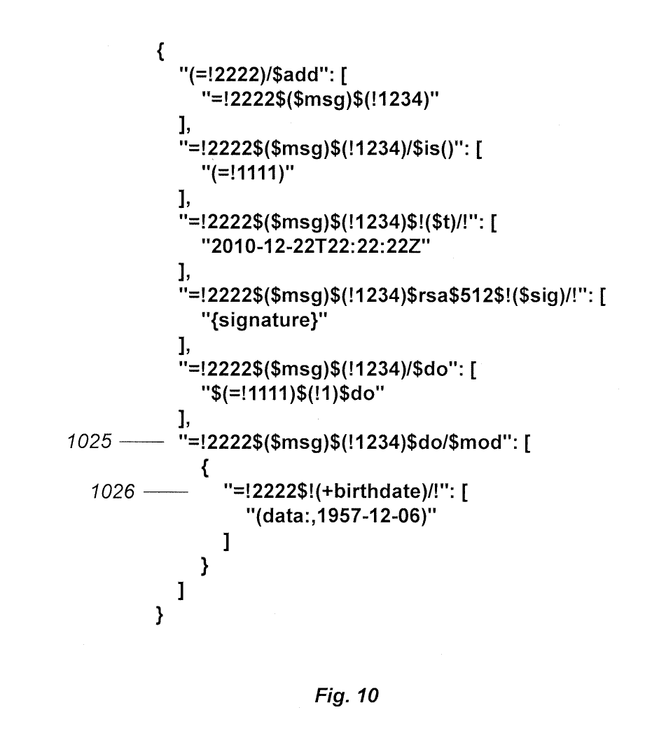

FIG. 10 illustrates the JSON serialization of an XDI message with a $mod operation. Again the first five XDI statement are identical to FIG. 8. The operation statement 1025 is a $mod operation which, like a $add operation, operates on a subgraph of XDI statements. In this example there is just one statement 1026, which will modify the value of the birthdate literal value that was added to the graph using statement 926 in FIG. 9.

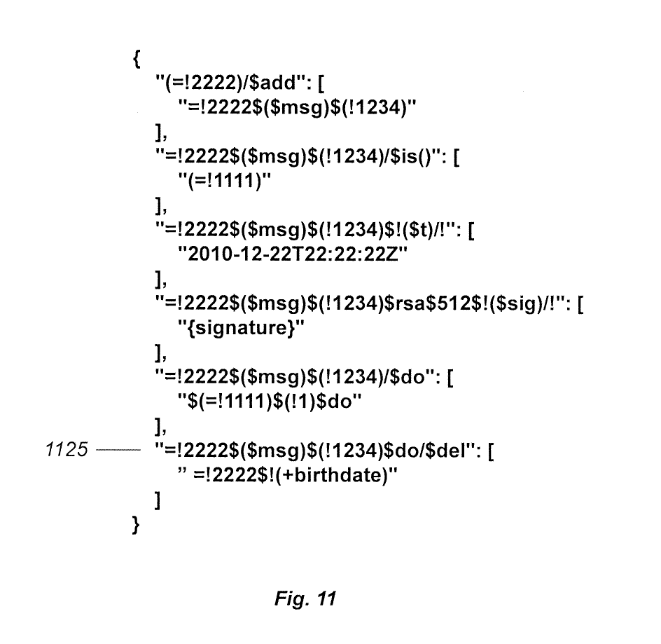

FIG. 11 illustrates the JSON serialization of an XDI message with a $del operation. Again the first five XDI statement are identical to FIG. 8. The operation statement 1125 is a $del operation which, like a $get operation, operates on a set of XDI addresses. In this example there is just object in statement 1125, which is the birthdate literal node added using statement 926 in FIG. 9 and modified using statement 1026 in FIG. 10. Statement 1125 would result in this literal node being deleted from the =!2222 context node.

The parent patent application referenced above discloses techniques for joining and maintaining a trust network. Using these techniques, the people or organizations represented by digital identities, referred to as principals, enter into a membership relationship with the legal entity operating the trust network, called the trust network provider. This relationship conveys certain rights and benefits to the principals and also entails certain responsibilities and duties for the principals. Therefore, it is both a legal and a technical relationship, and it is embodied as both a legal contract and an XDI link contract.

In this process, either the dumb client 110 (FIG. 1) or the smart client 210 (FIG. 2) is used to register the principal as a member of the trust network and enter the principal into a legal contract with the trust network. This legal contract is embodied in a trust framework used by the trust network, and the principal's consent to this contract is represented as a machine-readable XDI link contract of which both the principal and the trust network have a copy. This contract for membership in the trust network sends an initial verifiable signal to the other members of the trust network that the principal intends to abide by the principles and rules specified by the trust framework. The trust framework may be further improved by requiring members to participate in a peer-to-peer reputation system in which members may vouch for the other members of the network whom they trust in specific contexts. These vouches become additional signals of trust that can be viewed directly by other members of the network (or the public), or made available via APIs (application programming interfaces) to other applications or services, in order to facilitate making trust decisions.

These capabilities of the trust network provide the basis for the novel techniques for address book automation disclosed herein. These techniques are applicable to address books maintained on or by any device or application that has access to the trust network via one or more communications networks such as the Internet. From the viewpoint of these devices or applications, the trust network makes both the digital identity and the address book capabilities of the principal available “in the cloud”. For this reason this new solution to address book automation can be referred to as a cloud address book. A cloud address book is one example of the generalized capabilities that the aforementioned trust network provides to a principal to store, manage, and share his/her digital identity and personal data via the trust network. Thus a cloud address book application is referred to as a personal cloud application. If the trust network supports multiple data service providers, these data service providers are referred to as personal cloud providers.

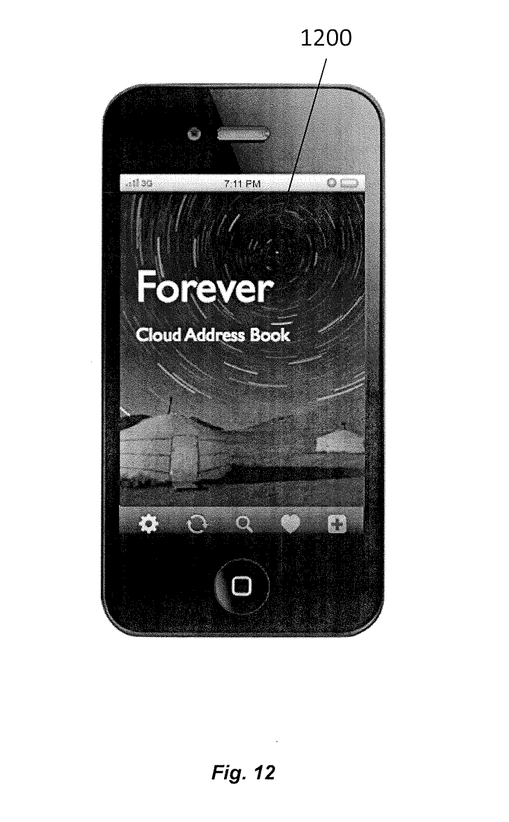

FIG. 12 is an embodiment of the opening screen (“splash screen”) 1200 of the Forever™ mobile cloud address book application from Respect Network™ Corporation. This embodiment is shown on an Apple iPhone,™ however in an alternate embodiment this application could be implemented on any modern smartphone operating system or hardware. This mobile application is one embodiment of the client-side cloud address book capabilities disclosed in this specification. In an alternate embodiment, the client-side capabilities of a cloud address book may be embodied on a local device as a browser plug-in, as an operating system module or library, or incorporated into another standalone application such as an email, instant messaging, or VoIP client. These same client-side address book automation features may also be incorporated into server-side address books such as those used by Web mail services such as Gmail™ and Yahoo Mail.™ The particular form of the client-side functionality is not a limiting feature of the invention.

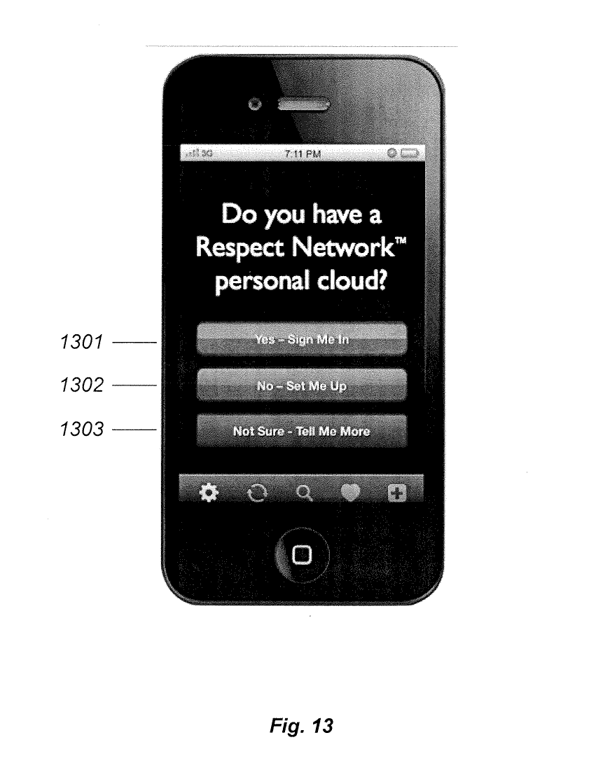

FIG. 13 is a setup screen for the Forever cloud address book application. If the user is already a member of the trust network, button 1301 initiates the process of connecting the client app to the server-side personal cloud functionality. If the user is not yet a member of the trust network, button 1302 initiates the process of enrolling the user as a member as disclosed in the previously referenced parent patent application. If the trust network supports multiple personal cloud providers operating as data service providers, the enrollment process will also enable the user to select his/her preferred personal cloud provider. Button 1303 enables the user to learn more about the benefits of the trust network, personal clouds, and personal cloud applications.

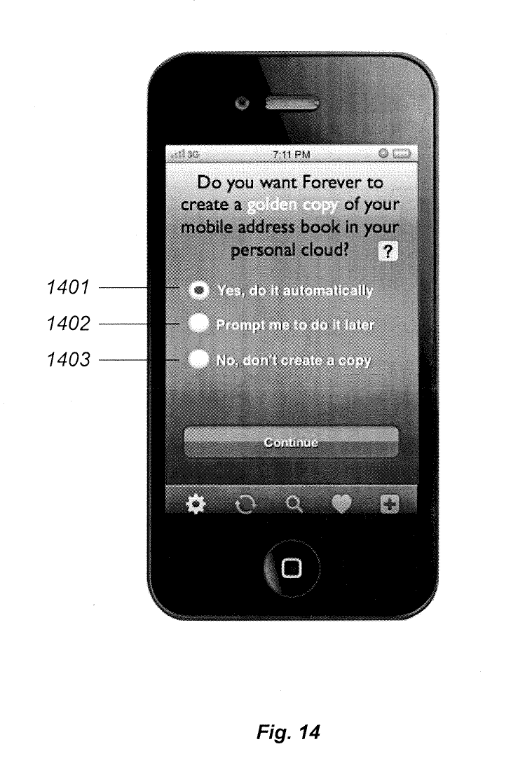

FIG. 14 is a configuration screen for the Forever cloud address book application. This screen enables the user to configure his/her preferences for one of the features of a cloud address book: the capability for the user to maintain a master copy of their address book in their personal cloud, i.e., at the XDI endpoint for their digital identity on the trust network. Since the user is authoritative for this copy, including his/her own contact data stored in it, in the industry this is referred to as the user's “golden record” or “golden copy”. Radio button 1401 lets the user instruct the cloud address book application to create this golden copy automatically. Radio button 1402 lets the user instruct the application to remind him/her create a golden copy at a subsequent time. Radio button 1403 lets the user choose to not have the application make a golden copy in the user's personal cloud, but to work directly off the local address book that comes with the device, such as the Apple Address Book™ that ships with the iPhone.™

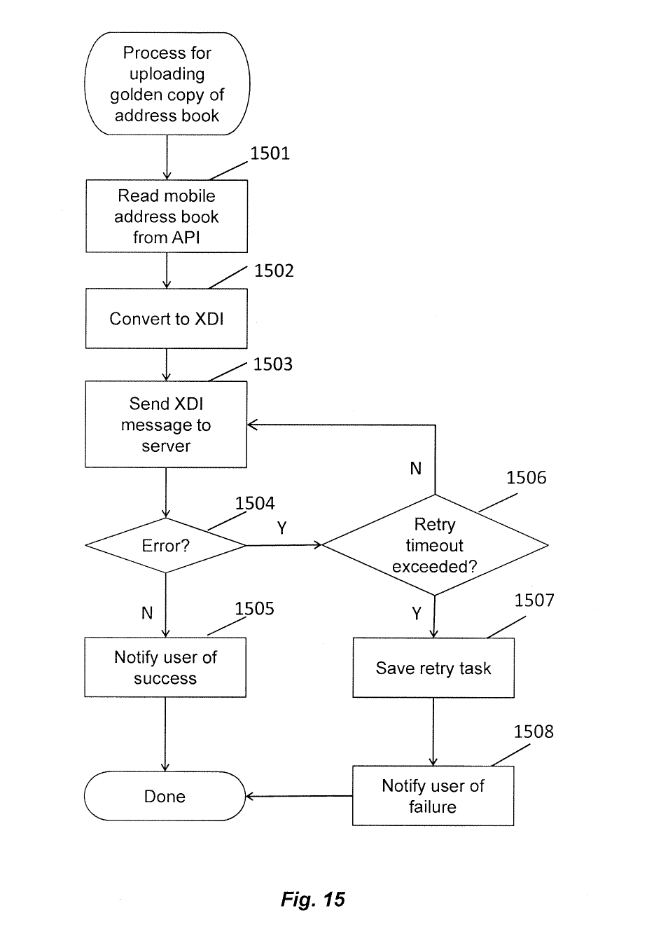

FIG. 15 illustrates an example method for the cloud address book application functioning as smart client 210 to create the golden copy in the user's personal cloud. In step 1501, the smart client 210 reads the user's mobile address book using its own local API. In step 1502, smart client 210 converts the local address book data into XDI using an XDI dictionary. XDI dictionaries are ontologies written in XDI as explained on the XDI Technical Committee website. Such a dictionary may be developed and maintained by any XDI authority, such as the developer of the cloud address book application or by the trust network operator to facilitate interoperability of cloud address book applications across the trust network.

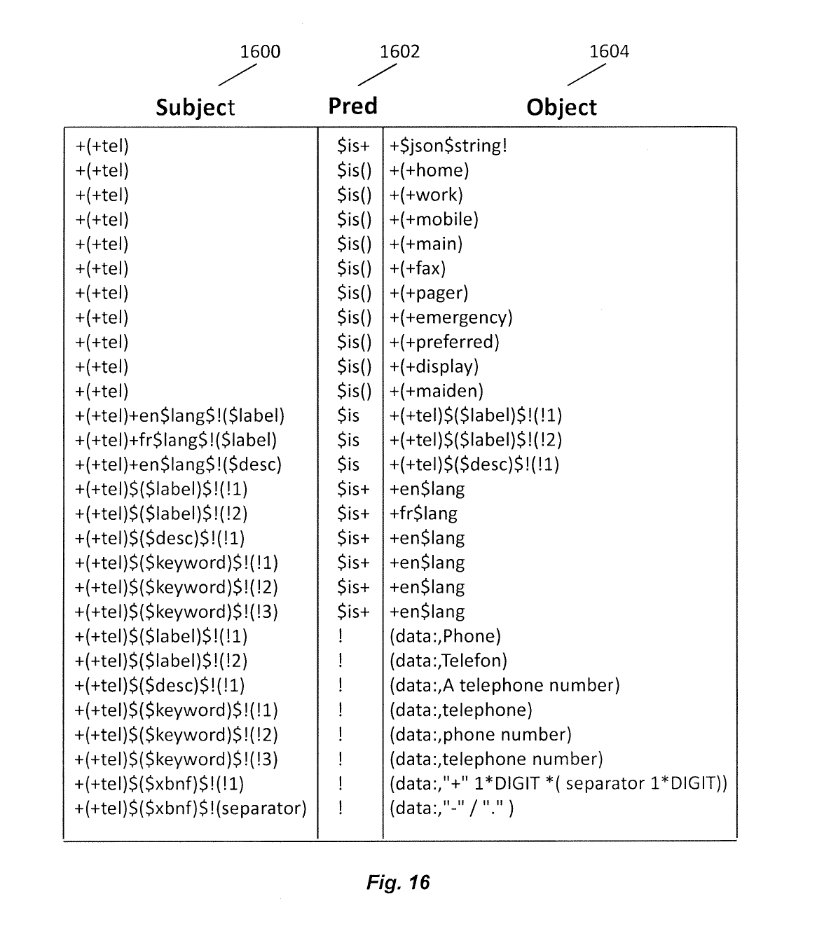

FIG. 16 is an example XDI dictionary entry defining a telephone number using the XRI +tel. Each of the XDI contexts in which a telephone number might be used (home, work, mobile, fax, and so on) are defined using the $is( ) predicate. The different dictionary attributes of the definition (label, description, keywords, and so on) are each expressed with XDI statements (shown in three columns 1600, 1602 and 1604 respectively representing the XDI subject, predicate, and object). The formal ABNF grammar definition of a valid phone number literal is given by the final two statements using a format called XBNF (XDI BNF). XBNF allows standard ABNF text statements to be written as XDI-addressable literal data values. ABNF is defined by RFC 5234 from the Internet Engineering Task Force (IETF).

Having converted the user's local address book into XDI, in step 1503 of FIG. 15 smart client 210 sends an XDI message containing this data to the XDI endpoint of the user's personal cloud, where it will be stored by the XDI server in the user's XDI graph. In step 1504 the smart client 210 checks the server response for an error. If there is no error, in step 1505 smart client 210 notifies the user of success and the process is complete. If there is an error, in step 1506 smart client 210 checks to see if a retry timeout has been exceeded. If not, smart client 210 loops back to step 1503. If yes, in step 1507 it saves a retry task, and in step 1508 notifies the user that it will try again later to upload the golden copy.

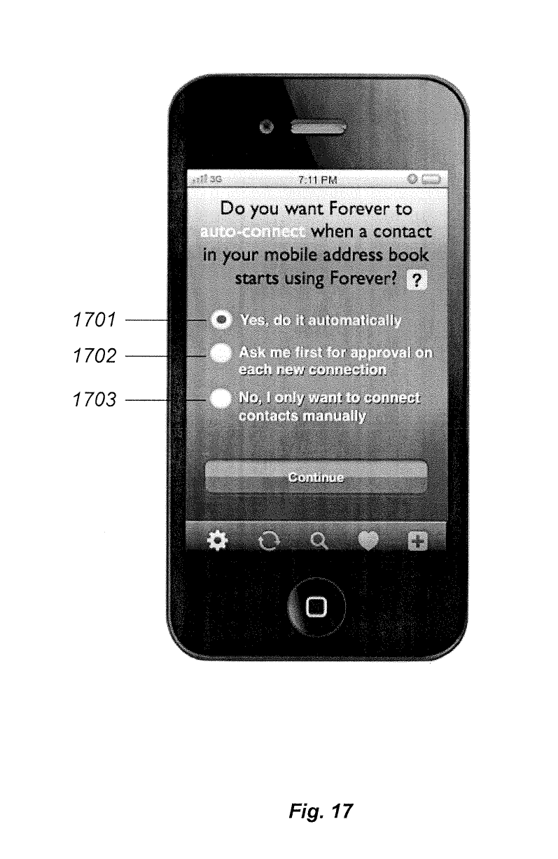

FIG. 17 is a configuration screen for the Forever cloud address book application that enables the user to configure his/her preferences for another feature of a cloud address book: the capability for it to automatically form connections with contacts who are already in the user's mobile or other local address book. Radio button 1701 lets the user select for the cloud address book application to form these connections fully automatically. Radio button 1702 gives the user the option to approve each connection before it is completed. Radio button 1703 lets the user select to not have the connections made automatically, but only when manually initiated by the user as further described herein.

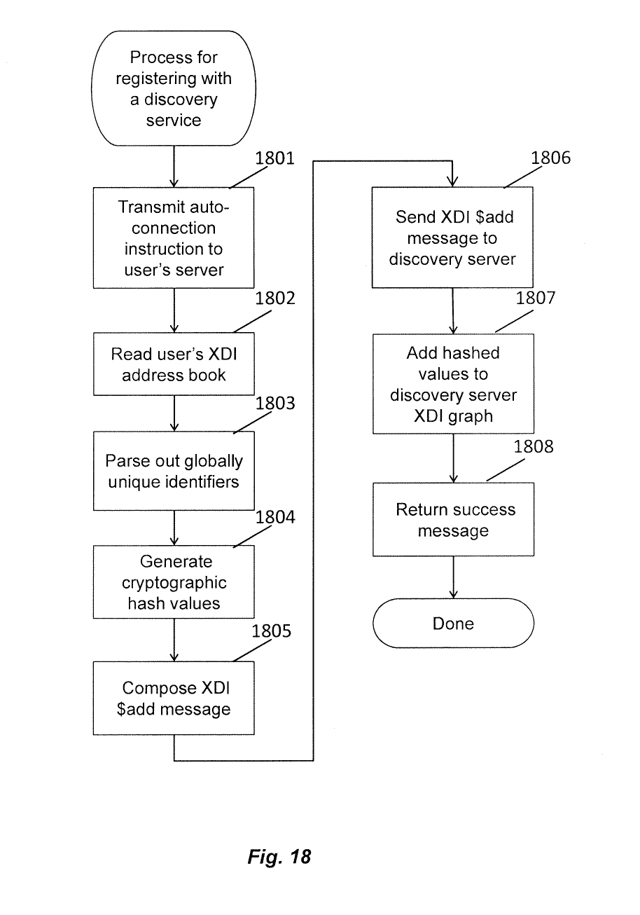

FIG. 18 illustrates the first portion of an example method for the cloud address book application to automatically form connections (“auto-connect”) as instructed by the user selecting radio button 1702 in FIG. 17. For purposes of illustration, this example will assume that the user has selected to store a golden copy of his/her address book in his/her personal cloud (radio button 1401, FIG. 14). In step 1801, smart client 210 transmits the user's instruction to initiate auto-connections to the user's server 120. In step 1802, the user's server 120 reads the user's address book stored in the user's XDI graph. In step 1803, the user's server 120 parses out the globally unique identifiers for the user and each of the user's contacts. Globally unique identifiers present in typical address book applications include but are not limited to: telephone numbers, email addresses, instant messaging addresses, social networking addresses (including Twitter™ handles, Facebook™ URLs, and LinkedIn™ URLs), other forms of URLs and URIs, and XRI i-names and i-numbers. In step 1804, the user's server 120 generates a hash using a cryptographic hash function for each of these unique identifiers in a form proscribed by the trust network operator. While not strictly necessary from a functional standpoint, the use of a cryptographic hash such as SHA-1 to produce a hashed value for discovery purposes avoids the privacy issue of having unique identifiers, particularly communications addresses, stored in the clear in a centralized index. The particular cryptographic hash function selected is not a limiting feature of the invention. In step 1805, the user's server 120 composes an XDI $add message to add the user's own hashed globally unique identifiers, together with the user's XDI i-number assigned by the trust network as the address for the user's XDI endpoint, to another server 120 that functions as the cloud address book discovery server. In this specification this server 120 will be referred to as the discovery server 120. In step 1806 the user's server 120 sends this XDI $add message to the discovery server 120. In step 1807 the discovery server 120 performs this $add operation and stores the user's hashed identifiers with a link to the user's XDI i-number in the discovery server 120's XDI graph. In step 1808 the discovery server 120 returns an XDI success response to the user's server 120. The user's account on the trust network is now registered for auto-connections.

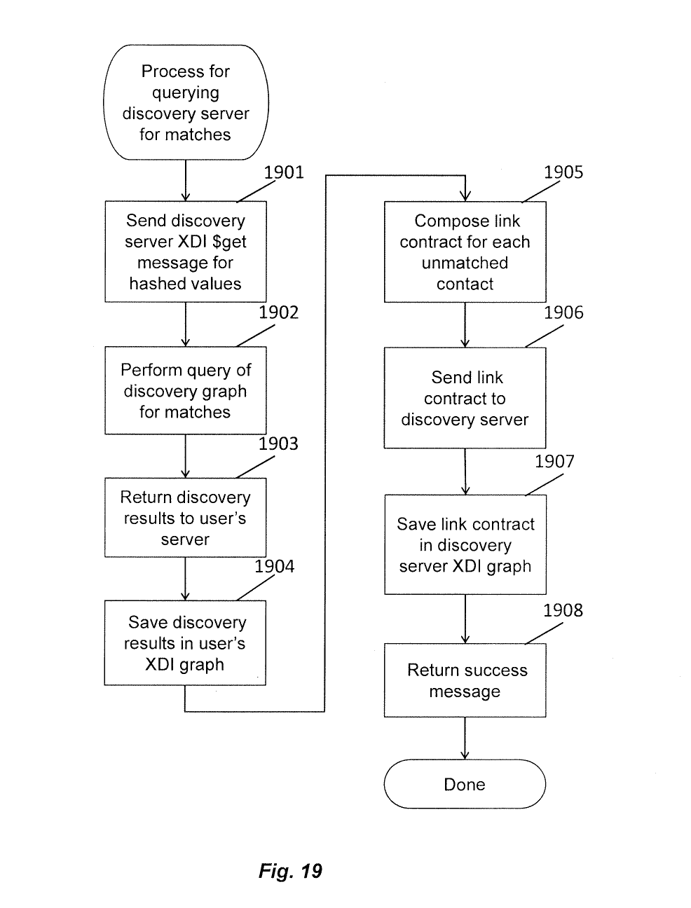

FIG. 19 illustrates the second portion of an example method for the cloud address book application to form auto-connections. In step 1901 the user's server 120 sends the discovery server 120 an XDI $get message requesting the XDI i-number associated with each of the hash values representing globally unique identifiers for the user's contacts generated in step 1803 of FIG. 18. In step 1902, the discovery server 120 performs a query of its XDI graph to determine matches. In step 1903, the discovery server 120 returns the XDI i-number for each match, and an error for each non-match. In step 1904, the user's server 120 saves the matches in the user's XDI graph, creating a graph of the user's contact relationships that are present on the trust network. For each match, the user's server 120 is now ready to form the auto-connection. For the non-matches, the user's server 120 performs step 1905, in which it composes an XDI link contract for each unmatched contact. This link contract requests an XDI $copy permission for the XDI i-number associated with each hashed value associated with the unmatched contact. This link contract will serve as the subscription mechanism so that the user's server 120 will receive an XDI $copy message if and when the contact associated with the hashed value is registered with the discovery server 120. In step 1906, the user's server 120 sends an XDI $add message with the link contract to the discovery server 120. In step 1907, the discovery server 120 stores a copy of this link contract. In step 1908, the discovery server 120 returns an XDI success response to the user's server 120. The user's unmatched contacts are now registered with the discovery server 120 so that connections can be formed automatically if and when the associated contact is registered with the discovery server 120.

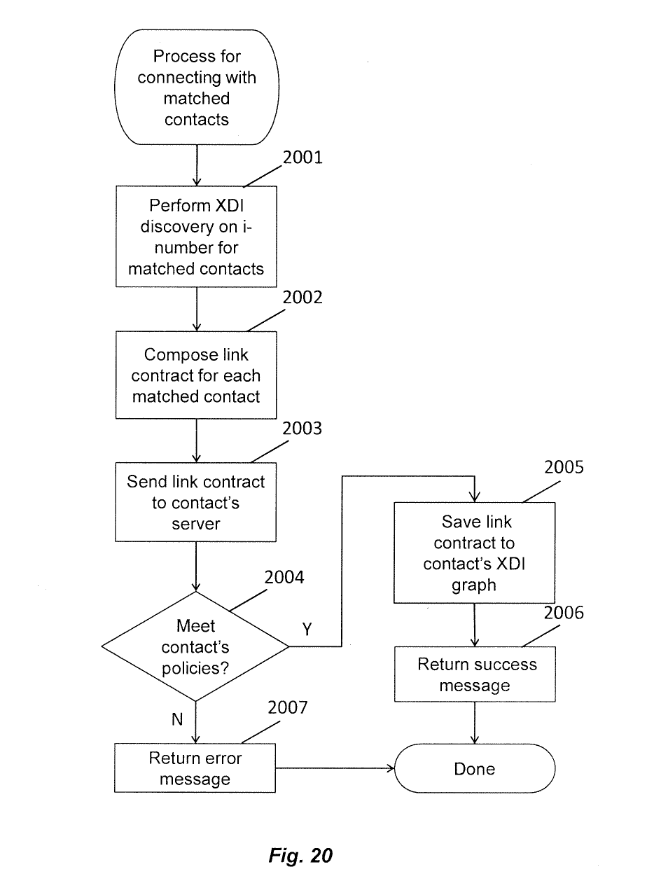

FIG. 20 illustrates the third portion of an example method for the cloud address book application to form auto-connections. In step 2001, the user's server 120 first does XDI discovery on the XDI i-number for each matched hash value to obtain the URI of the XDI endpoint for each associated contact. The process of XDI discovery is specified on the XDI Technical Committee website. Having obtained the URI for each XDI endpoint, in step 2002 the user's server 120 composes an XDI link contract for each matched contact. This link contract follows the basic pattern shown in FIG. 5, i.e., it specifies the set of contact data that the user is volunteering to share with the contact. In one embodiment, this set of contact data is represented as an XDI persona as illustrated in FIG. 4D and FIG. 5. In one embodiment, the user employs the cloud address book application acting as smart client 210 to create such a persona. The user may also employ other client-side or server-side applications for persona management. The persona management application is not a limiting feature of the invention. In one embodiment, a contact persona is represented to the user by persona management application as a business card. The persona management application user interface enables the user to add, edit, and delete these business cards as a means of managing his/her contact personas. Since the user may also choose to share multiple personas with one or more contacts, this may take the form of selecting multiple business cards. In step 2003, the user's server 120 sends an XDI $add message with the XDI link contract to the XDI endpoint of the server 120 representing each matched contact. In step 2004, the contact's server 120 receives and evaluates the proposed XDI contract. If it is acceptable according to the contact's policies, in step 2005 it is saved to the contact's XDI graph. In step 2006 the contact's server 120 returns an XDI success response to the user's server 120. If it is not accepted according to the contact's policies, in step 2007 the contact's server 120 responds with an error.

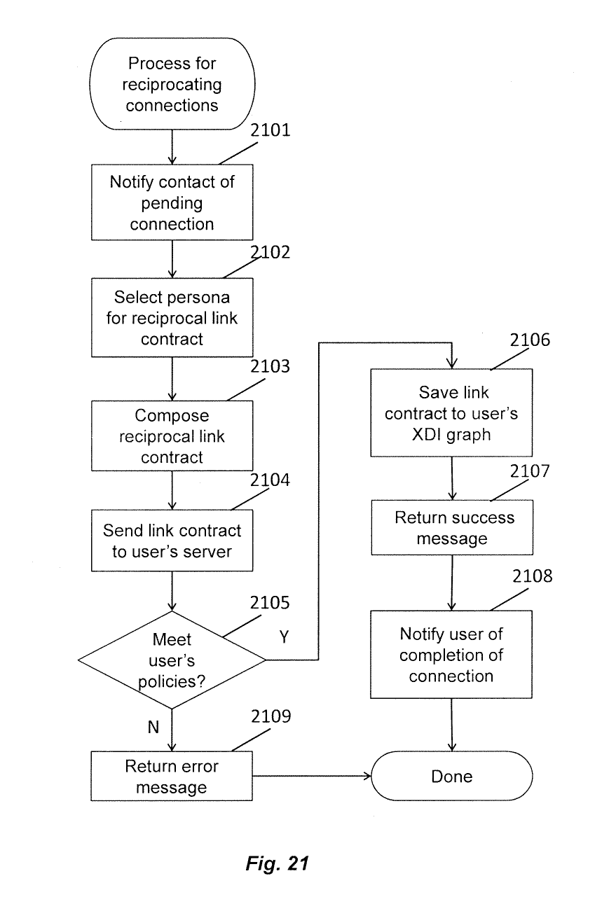

FIG. 21 illustrates the fourth portion of an example method for the cloud address book application to form auto-connections. In this portion the link contract proposed by the user's server 120 in FIG. 20 is reciprocated by the contact's server 120. This example assumes that the contact's preference is to be notified about pending connections and then to manually select the contact persona (business card) to share in reciprocation. In step 2101, the contact's server 120 notifies the contact of the pending connection. This message includes or references a means for the contact in step 2102 to select the desired persona or business card to share in order to complete the connection. This step may be accomplished using the smart client 210, or a web interface to the contact's server 120, or another means. In step 2103, the contact's server 120 composes the link contract for this reciprocal contact data sharing relationship. In step 2104, the contact's server 120 sends the proposed link contract to the user's server 120. In step 2105, the user's server 120 evaluates the proposed link contract to determine if it satisfies the user's policies. Since it is a reciprocal link contract, this will generally be true. If so, in step 2106 the user's server 120 saves the link contract. In step 2107 the user's server 120 returns an XDI success response to the contact's server 120. In step 2108, the user's server 120 notifies the user according to the user's notification preferences of the completion of the pending connection. If the link contract is not accepted in step 2105, then in step 2109 the user's server 120 returns an XDI error response to the contact's server 120. This completes the auto-connection process.

There are multiple benefits to this automatic connection process facilitated by the trust network. First, no explicit invitation is required. In most social networks and network contact management solutions, contacts must be sent an invitation to form a relationship and each contact must respond to this invitation in order to complete the connection. This “opt-in” design is necessary both to protect privacy and to ensure that users are in control of their data and relationships. With the auto-connection process described herein, the user only needs to “opt-in” once in the process of becoming a member of the trust network. Thereafter the user is assured that other members of the trust network have agreed to the principles and rules of the governing trust framework. Provided these rules ensure that the privacy of the user's data will be protected and the user's right to control their data and relationships will be respected, users can be confident that personal cloud applications like a cloud address book will observe their personal preferences for relationship management and contact data sharing. This confidence will be further increased if the trust network employs reputational feedback mechanisms such as the vouching capability described in the previously referenced parent patent application. In the case of the automatic connection process described herein, the presence of contact data (in the form of one or more globally unique identifiers) in a user's own existing address book is used as a signal that the user desires to form a connection with that contact automatically if the trust network is able to facilitate this process.

If a user prefers for connections to not be formed fully automatically, the user may select to approve new connections manually. An example user interface for making such a selection is shown as radio button 1702 in FIG. 17. Users may choose this option in order to be selective about the contacts with whom they are making connections, to control which persona or personas (business cards) they wish to share with specific contacts, to group or categorize contacts in their XDI graph, or for other relationship management purposes. If the user selects this option, the auto-connection process described previously is interrupted before block 2003 in FIG. 20. Rather than proceeding entirely automatically, the user's server 120 notifies the user of each proposed link contract representing a connection with a contact already existing in the user's address book. The user's server 120 may provide this notification by communication with the cloud address book smart client 210; or by sending an email, text, or other message to the user; or by composing a report of proposed connections to be reviewed by the user the next time the user invokes a web interface for the user's server 120; or by any other means available to the user's server 120 and the user for obtaining approval. The means of notification and approval are not a limiting feature of the invention. The approval process may also incorporate the user's selection of the persona or personas (which in one embodiment are represented as business cards) that the user wishes to share in the context of each specific connection as described in FIG. 20.

In an alternative embodiment, a user may apply policies to the process of determining whether the completion of a connection should be fully automatic, whether a specific persona or personas should be shared, whether the connection should be classified in specific groups or categories, or other relationship management functions. In one embodiment these policies are applied at the user's server 120. In an alternate embodiment they are applied at the smart client 210. In either of these embodiments, the policies may be enforced by the cloud address book server or client application code. In an alternate embodiment, the policies are enforced by the use of a rules engine, and the policies are implemented in a rules language configured by the user or by other applications employed by the user. An example rules engine and language that may be employed for this purpose is the Kinetic Rules Engine and Kinetic Rules Language from Kynetx™ Corporation. Rules processing in a cloud address book application can provide significant additional automation when used in conjunction with the vouching and reputation management features of a trust network as described in the previously referenced parent patent application. In particular, the user may configure a rule to automatically approve a connection if the contact's trust level meets a specified threshold; if the contact's vouch count on one or more tags meets a specified threshold; if the number or type of tags shared between the user and the contact meets a specified threshold; if the number of common connections the user and the contact share with other members of the trust network or on other networks meets a specified threshold; if the number of registered complaints against a contact is below a specified threshold; and so on. Rules may also be configured to automatically suggest or assign the personas (business cards) to share with the contact based on the contact's trust level, tags, vouch counts, shared connections, and so on.

A second benefit of the automated connection capability of a cloud address book is that once a connection is made, it can provide automated synchronization of updates to contact data. These updates can flow in both directions, i.e., from the user to connected contacts, and from connected contacts to the user. The user can also control whether these updates flow only to the user's server 120, or if the user employs a smart client 210, updates can be delivered directly to the user's mobile address book or any other connected application or device.

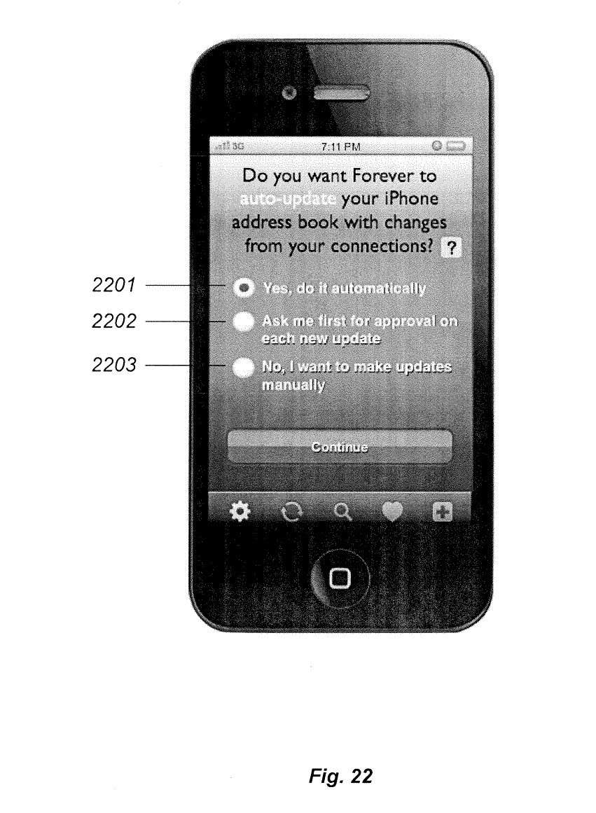

FIG. 22 is a configuration screen for the Forever cloud address book application that enables the user to control synchronization preferences. Radio button 2201 lets the user specify that updates should automatically be downloaded to the user's mobile address book. Radio button 2202 gives the user the option to approve each update before it is made. Radio button 2203 lets the user select to not have the updates downloaded automatically, but only manually by the user.

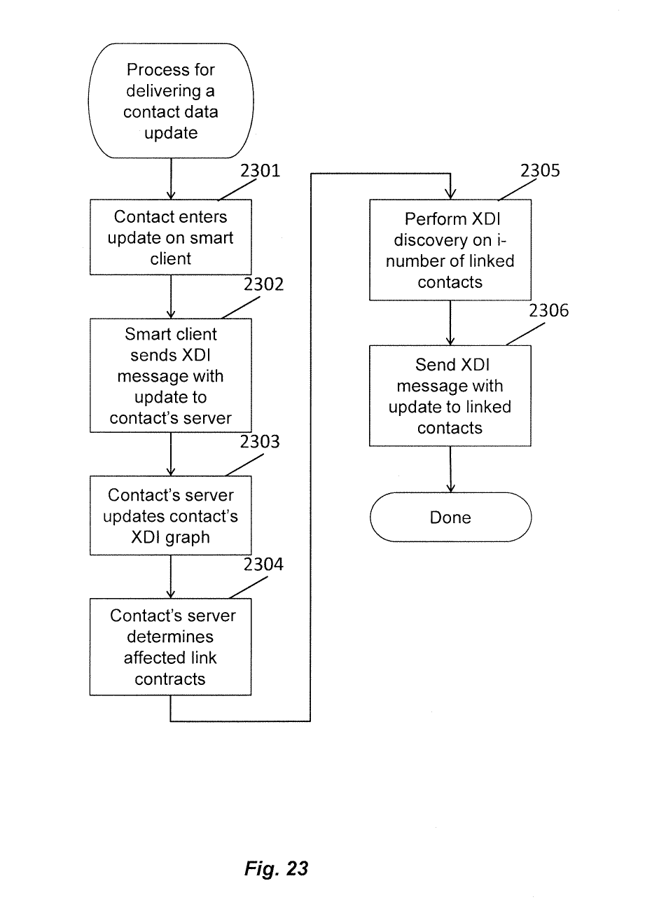

FIG. 23 illustrates the first portion of an example method for a cloud address book application that includes a smart client 210 to deliver an update from a connected contact to the user's mobile address book. For purposes of this example, we will assume the contact is also using a cloud address book application on a smart client 210, however the contact may also initiate the update via a web interface to the contact's server 120, or via any other application that can communicate the update to the contact's server 120. In step 2301, the contact enters the updated contact data on the contact's smart client 210. In step 2302, smart client 210 sends an XDI message with the applicable $add or $mod operations (depending on what changes the contact is making) to the contact's server 120. In step 2303, the contact's server 120 makes the changes to the contact's XDI graph. In step 2304, the contact's server 120 traverses the contact's XDI graph to determine the affected link contracts, i.e., those that have XDI $copy operations and reference the updated contact data, either directly or via one or more personas. In step 2305, the contact's server 120 performs XDI discovery on the i-numbers of the linked contacts to determine the URI of their current XDI endpoint. In step 2306, the contact's server 120 sends an XDI message with the applicable $add or $mod operations to the linked contacts.

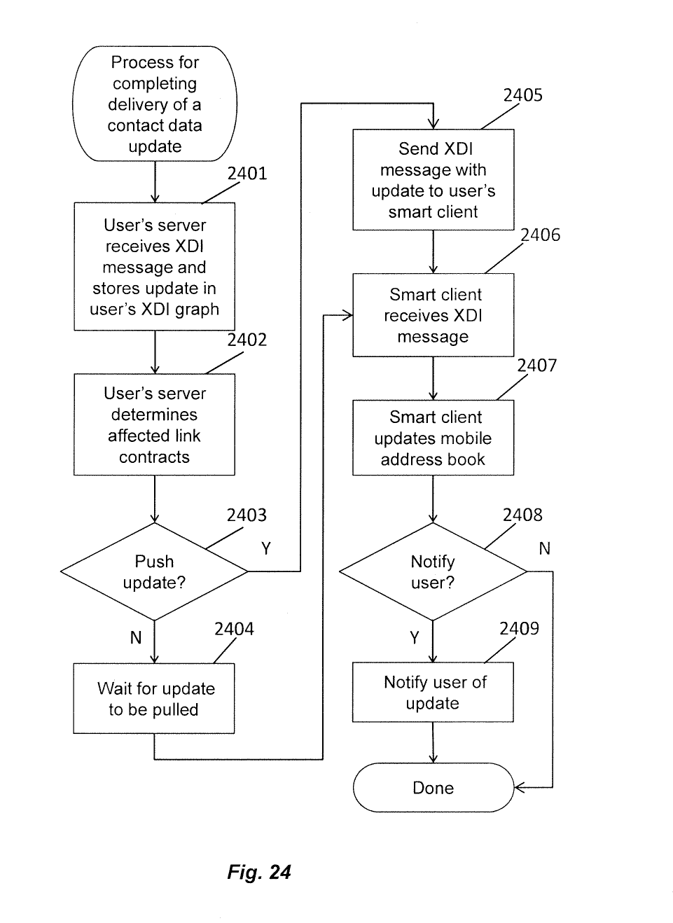

FIG. 24 illustrates the second portion of an example method begun in FIG. 23. In step 2401, the user's server 120 receives the XDI message with the contact data update and stores it in user's XDI graph. In step 2402, the user's server 120 traverses the user's XDI graph to determine which link contracts with XDI $copy operations reference the updated contact data. Since the user has configured address book changes to be downloaded automatically into the user's mobile address book, the user's smart client 210 has such a link contract with the user's server 120. In step 2403, the user's server 120 checks the user's preferences for whether an update should be pushed or pulled. If pulled, in step 2404 the user's server 120 queues the XDI message for the user's smart client 210 to pull. If pushed, in step 2405 the user's server 120 pushes an XDI message with the applicable $add or $mod operations to the smart client 210. In step 2406, the user's smart client 210 receives the message. In step 2407, smart client 210 calls the API of the user's mobile address book to apply the update. In step 2408, smart client 210 checks to see if the user has configured his/her notification preferences to be notified of updates. If so, in step 2409 smart client 210 notifies the user of the update. This completes the update delivery process.

Cloud address book synchronization on a trust network that uses XDI discovery of persistent XDI i-numbers for addressing and a trust framework that gives members the right to data portability delivers an even greater benefit to trust network members: lifetime connections. In other words, once established, a connection between two members will never break no matter how often either member changes contact data or changes data service providers. This is the origin of the cloud address book brand name “Forever” used by Respect Network Corporation.

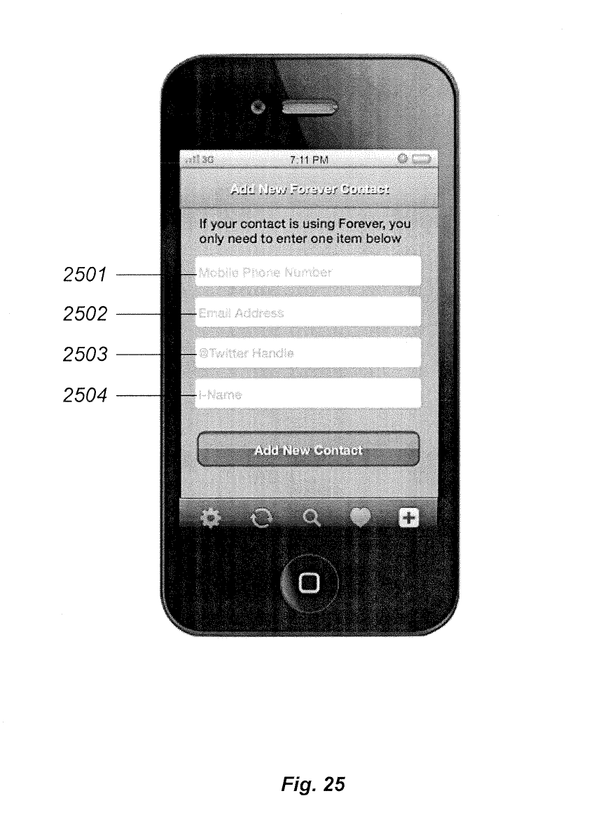

FIG. 25 is a screen from the Forever cloud address book application that illustrates the user interface for another feature of a cloud address book: the capability to add a connection to a new contact with as little as a single globally unique identifier for that contact. Data entry field 2501 is a text box for entering a mobile phone number. Data entry field 2502 is a text box for entering an email address. Data entry field 2503 is a text box for entering a Twitter™ handle. Data entry field 2504 is a text box for entering an i-name (a reassignable XRI). As discussed previously, all four of these are globally unique identifiers whose usage and control by a specific individual or other principal may be verified via various well-known techniques such as closed-loop authentication or the OAuth authorization framework being standardized the Internet Engineering Task Force. Any type of globally unique identifier whose control by a principal can be verified may be used for this purpose. The specific type of globally unique identifier is not a limiting feature of the invention.

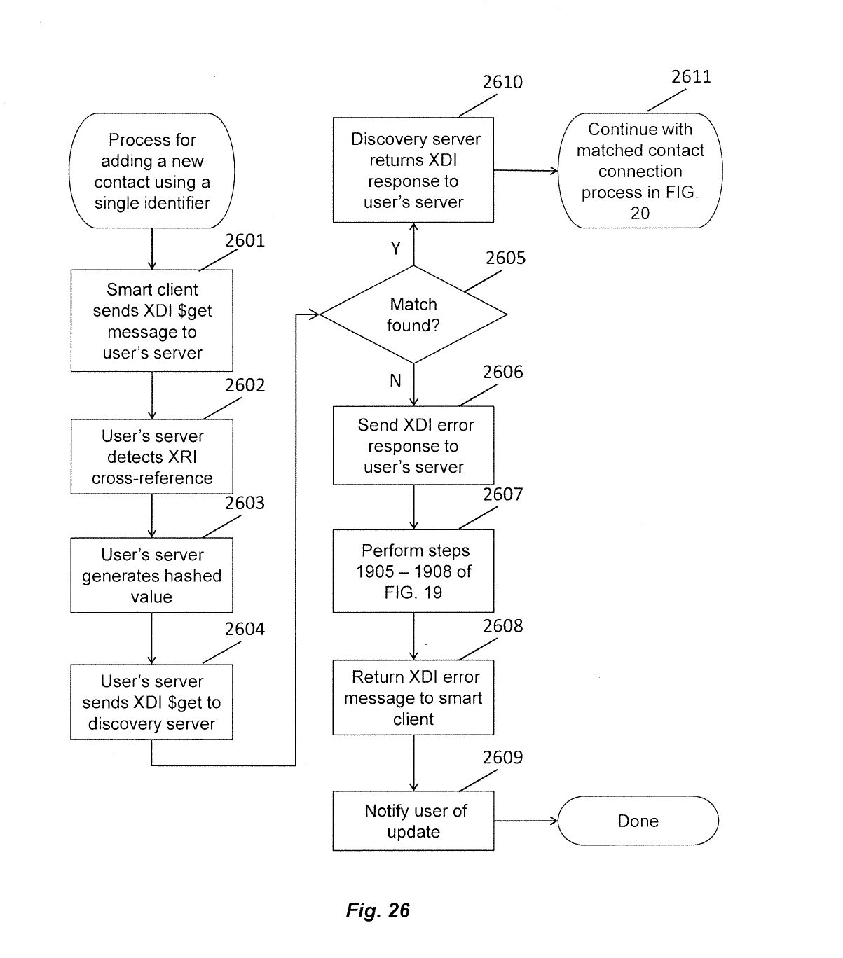

FIG. 26 illustrates an example method for a cloud address book application to add a new connection using any one of the globally unique identifiers entered in FIG. 25. In step 2601, smart client 210 sends an XDI $get message with an XRI cross-reference to the globally unique identifier to the user's server 120. An XRI cross-reference is a syntactic construction defined in the XRI 3.0 specification from the OASIS XRI Technical Committee that enables an identifier assigned in one context to be reused in another context. For example, to turn the email address “example@example.com” into an XRI cross-reference, it is first converted into a URI by giving it a URI scheme prefix and is then enclosed in parentheses, i.e., “(mailto:example@example.com)”. In step 2602, the user's server 120 parses the XDI message and detects that the $get operation is for an XRI cross-reference. The presence of a global cross-reference triggers the user's server 120, in step 2603, to generate a cryptographic hash of the globally unique identifier that it can use for lookup at the discovery server 120. In step 2604, the user's server 120 sends a XDI $get message to the discovery server 120 to query if the globally unique identifier has been registered. In step 2605, the discovery server 120 does a lookup against its XDI graph to determine if the hashed value has been registered. If not, in step 2606 it returns an XDI error message. In step 2607, the user's server 120 performs the process of adding an XDI link contract with the discovery server 120 described in steps 1905, 1906, 1907, and 1908 of FIG. 19. In step 2608, the user's server 120 returns an XDI error message to the smart client 210. In step 2609, the smart client 210 notifies the user according to the user's preferences that the contact is not yet registered for cloud address book discovery.

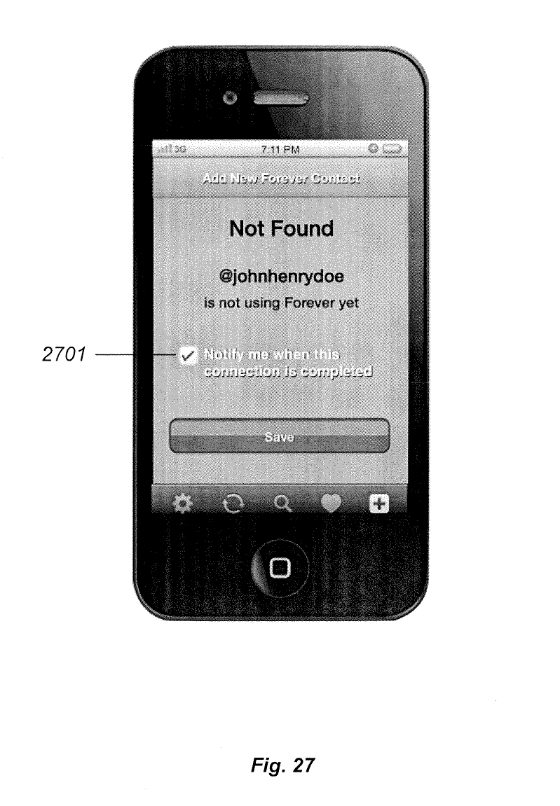

FIG. 27 is a screen from the Forever cloud address book application that is an example of how the user may be notified that the contact was not found using the globally unique identifier or identifiers entered using the user interface shown in FIG. 25. Checkbox 2701 is an example of an interface that enables the user to indicate his/her preference for whether the cloud address book application should notify the user if and when the connection is completed.

Returning to FIG. 26, if in step 2605 the result is yes, in step 2610 the discovery server 120 returns the XDI response to the user's server 120. In step 2611, the user's server 120 proceeds with the matched contact connection process shown in FIG. 20. If for any reason the link contract does not meet the contact's policy requirements in step 2004 of FIG. 20 and an error is returned, or if the process in FIG. 20 completes successfully but the contact's server 120 has not yet reciprocated using the process described in FIG. 21, then the connection is pending. If the process in FIG. 20 completes successfully and the contact's server 120 reciprocates using the process described in FIG. 21, then the connection is complete.

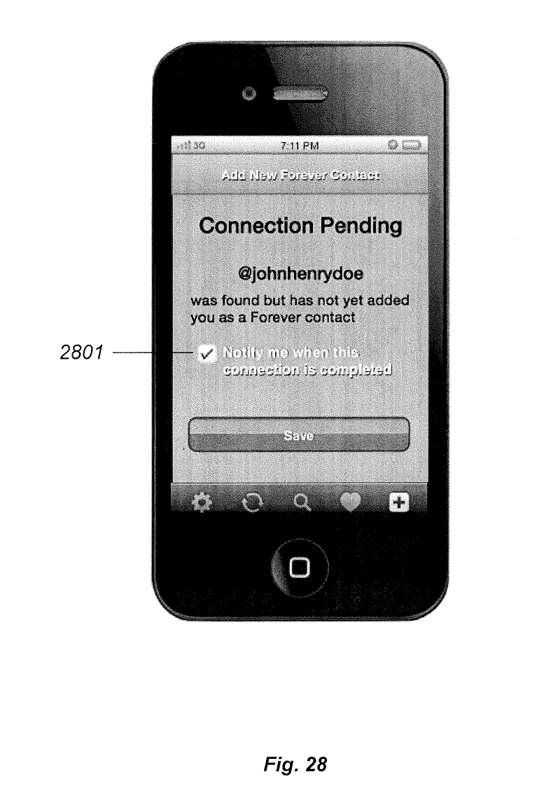

FIG. 28 is a screen from the Forever cloud address book application that is an example of how the user may be notified that a connection is pending. Checkbox 2801 is an example of an interface that enables the user to indicate his/her preference for whether the cloud address book application should notify the user if and when the connection is completed.

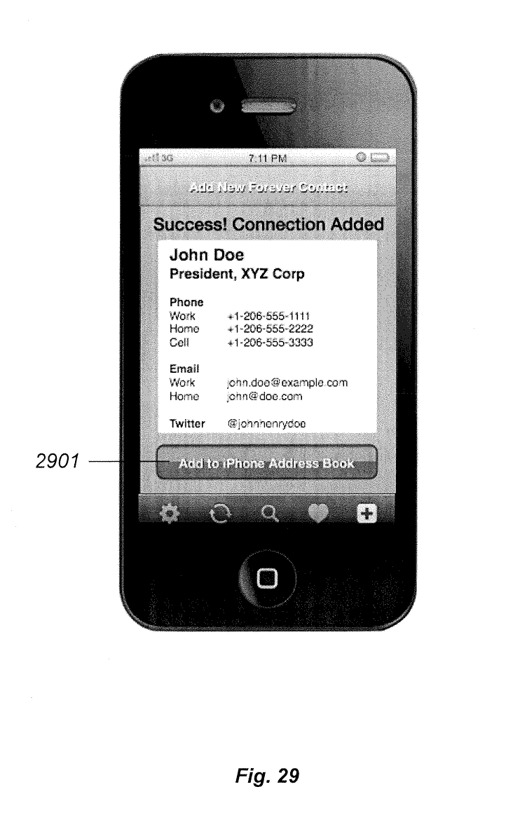

FIG. 29 is a screen from the Forever cloud address book application that is an example of how the user may be notified that a connection is complete. Button 2901 is an example of an interface that enables the user to proceed to add the new contact to his/her mobile address book (versus just having the contact present in the user's cloud address book).

Although considerable time and cost is saved in the process of adding a contact by entering only a single globally unique identifier, this process can be further simplified and automated by use of the digital camera and digital scanning capabilities of many modern smartphones, tablet computers, laptop computers, or other local devices.

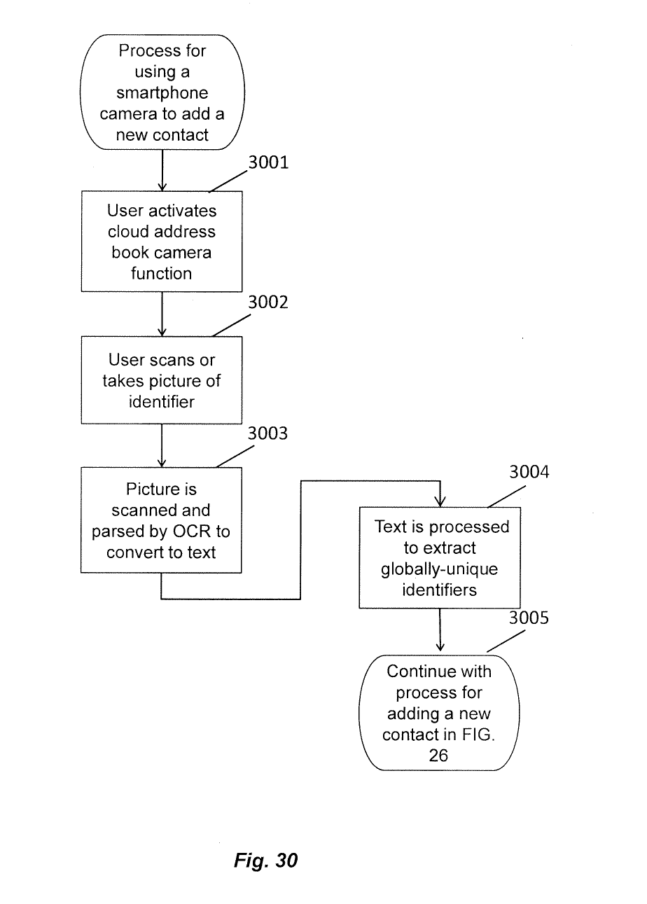

FIG. 30 illustrates an example method for using a smartphone camera to add a new connection. In step 3001, the user selects the cloud address book menu item on smart client 210 that invokes the camera function of the mobile phone operating system. In step 3002, the user takes a picture of anything that contains a written globally unique identifier for a new contact. Examples include business cards, slide presentations, trade show badges, signage, clothing (e.g., t-shirts, sweatshirts, hats), books, advertisements, billboards, and so on. In step 3003, the resulting picture is scanned and parsed by optical character recognition code to convert the written characters into digital text strings. In step 3004, these text strings are parsed to extract any globally unique identifiers as discussed in this specification. For example, telephone numbers, email addresses, Twitter handles, i-names, and URLs all have syntax rules that enable them to be parsed from text strings. In step 3005, processing of the extracted globally unique identifier or identifiers to add a new contact proceeds as described in FIG. 26.

Although written globally unique identifiers have the advantage of being easy to reproduce in many different mediums, they are not optimized for optical recognition. So in an alternate embodiment the method described in FIG. 30 is applied to QR codes, barcodes, or other forms of codes designed for optical code recognition. In this case, it may not be necessary for the user to take a picture. Simply scanning the code with the device's camera function can be sufficient to trigger recognition and translation of the code into a globally unique identifier such as a URL.

This technique for adding a new contact may be further improved by including a cloud address book function that enables the user to produce a globally unique identifier for each unique persona the user wishes to be able to share. This capability is particularly appropriate to identifiers that can be easily created and registered by the smart client 210 or user's server 120. Examples include custom URLs, delegated i-names, or custom QR codes. This technique is particularly appropriate to the metaphor of using a business card to represent the set of contact data a user is comfortable sharing under a specific persona. The presence of a custom i-name or a custom QR code on the business card makes it very easy for a contact to be add by the process described in FIG. 30.

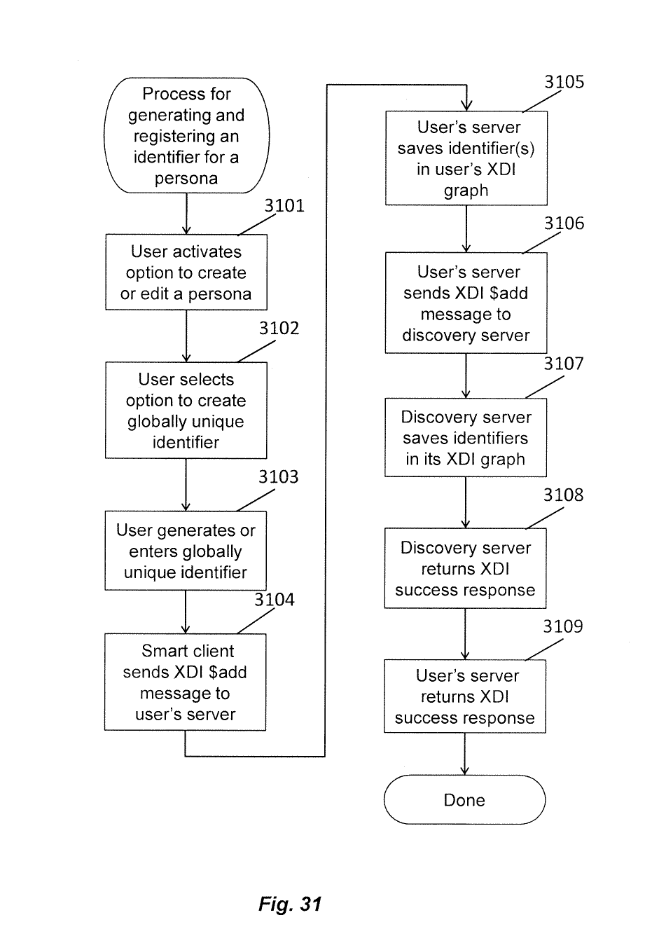

FIG. 31 illustrates an example method for generating and registering a globally unique identifier for a persona using a smart client 210. In step 3101, the user selects a user interface option to create or edit a persona. In step 3102, the user selects the option to create or enter a globally unique identifier of one or more of the identifier types previously discussed. In step 3103, the smart client 210 either automatically generates or lets the user manually enter the desired identifiers as text strings, QR codes, and so on. On a mobile device, these identifiers may need to be emailed or otherwise communicated to the principal in a reproducible format. In step 3104, the smart client 210 sends an XDI $add message with the generated identifiers to the user's server 120. In step 3105, the user's server 120 saves the generated identifiers to the user's XDI graph. In step 3106, the user's server 120 sends an XDI $add message with the generated identifiers to the discovery server 120. In step 3107, the discovery server 120 saves the generated identifiers to its XDI graph as part of the user's registration with the discovery server 120. In step 3108, the discovery server 120 returns an XDI success response to the user's server 120. In step 3109, the user's server 120 returns and XDI success response to the smart client 210. This completes the process of generating and registering a globally unique identifier for a persona.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A non-transitory computer readable storage medium, comprising instructions to:
receive a request from a client to enroll in a trust network, wherein the trust network is a group of entities that communicate in a digital network where communications between the entities are quantified to produce measures of entity trustworthiness;
supply a registration form to the client in response to the request;
process client data in the registration form received from the client, wherein the instructions to process include instructions to load the client data as parameters in a managed trust network, wherein the client data includes client address book contacts; and
administer the client address book contacts in accordance with the trust network measures of entity trustworthiness.

2. The non-transitory computer readable storage medium of claim 1 wherein the executable instructions to administer the client address book contacts include executable instructions to synchronize client address book contacts within the trust network.

3. The non-transitory computer readable storage medium of claim 2 wherein the executable instructions to synchronize include executable instructions to evaluate a trust network graph model with addressable nodes.

4. The non-transitory computer readable storage medium of claim 2 wherein the executable instructions to synchronize include executable instructions to evaluate whether to automatically contact an entity in a client address book when the entity becomes a member of the trust network.

5. The non-transitory computer readable storage medium of claim 2 wherein the executable instructions to synchronize include executable instructions to evaluate whether an entity in a client address book satisfies trust network policies.

6. The non-transitory computer readable storage medium of claim 1 further comprising executable instructions to add a contact to the client address book utilizing a single globally unique identifier.

7. The non-transitory computer readable storage medium of claim 6 further comprising executable instructions to alternately provide an indication of a contact connection pending, a contact connection failure and a contact connection success.

8. The non-transitory computer readable storage medium of claim 6 further comprising executable instructions to process an image of the single globally unique identifier.

9. The non-transitory computer readable storage medium of claim 6 further comprising executable instructions to process a code corresponding to the single globally unique identifier.
